(19) United States
(12) Patent Application Publication
(10) Pub. No.: US 2025/0335659 A1
(43) Pub. Date: Oct. 30, 2025

(54) SYSTEM AND METHOD FOR GENERATING PARAMETRIC FORMULAS USING MACHINE LEARNING AND ARTIFICIAL INTELLIGENCE

(71) Applicant: SEAMLY SYSTEMS, INC., Paducah, KY (US)

(72) Inventor: Susan Leigh Spencer, Paducah, KY (US)

(21) Appl. No.: 19/194,087

(22) Filed: Apr. 30, 2025

Related U.S. Application Data
(60) Provisional application No. 63/640,763, filed on Apr. 30, 2024.

(51) Int. Cl. G06F 30/20

(52) U.S. Cl. CPC G06F 30/20

(57) ABSTRACT

Ways for automating the generation of a parametric formula utilizing machine learning and artificial intelligence (AI) are provided. The system converts an image and measurement into interoperable design options, and includes a processor, a memory, a receiving module to receive the image and measurement corresponding to the image, a conversion module to analyze the image and measurement, an AI module to identify a pattern feature, a generation module to generate a parametric formula that receives a parametric input, a validation module to validate for accuracy and precision, an analysis module to structure measurement and parametric formula templates into parametric formulas, an application interface module to display and deliver the design option, and a manufacturing module to export the parametric formula to a manufacturing instruction. The parametric formula accommodates a wide range of body measurements, improving design efficiency, reducing manual steps, and enabling seamless integration across diverse design and manufacturing platforms.

### CROSS-REFERENCE TO RELATED APPLICATIONS

This application claims the benefit of U.S. Provisional Application No. 63/640,763, filed on Apr. 30, 2024. The entire disclosure of the above application is incorporated herein by reference.

### FIELD

The present technology relates to the field of digital apparel design and manufacturing, and, more particularly, to systems and methods for converting apparel patterns into scalable, parametric formula using machine learning and artificial intelligence.

### INTRODUCTION

This section provides background information related to the present disclosure which is not necessarily prior art.

The apparel industry faces challenges in creating garments that fit a diverse range of body types accurately and efficiently. Apparel design and manufacturing may rely on early nineteenth-century standardized sizing systems which provide fit for only one-third of consumers as they may not account for wide variations in body shapes. In other words, apparel designs may require manual generation of pattern outlines, which subsequently necessitate digitization and importation into software tools for further development. This garment sizing approach may often lead to ill-fitting garments, resulting in reduced sales rates, increased rates of returns, and low customer satisfaction and loyalty. This manual process may also introduce workflow inefficiencies, preventing agile design within the industry.

The process of designing and producing apparel for international markets may also be error-prone, labor-intensive, and time-consuming. For each apparel product, designers may be required to manually create a base pattern using body proportion assumptions for each market where the product will be sold. The designer may use ‘grading’ rules based on the body growth assumptions of each market to create a size range, resulting in a matrix of sizes. For example, the matrix of sizes may include Men's Regular, Men's Tall, and Men's Big and Tall; each with a size range between 38 and 52. If the design is sold in different geographic regions, such as the European Union, Korea, or Australia, these base patterns and size ranges may require complete redevelopment for the markets within those regions.

Designers may also be required to manually adjust patterns for each individual, a method that is not scalable for mass production. This manual intervention may not only increase the cost of production but also limit the ability to rapidly respond to market demands or individual customer needs. This design method may not be scalable or reliable for use in mass customized production and may not easily adjust to redefining or niche markets or be incorporated into new market data research for refined size ranges. Unsold apparel rates may often average approximately 40% and returned apparel rates approximately 20% primarily due to poor sizing. These manufacturing problems may result in low industry-wide profit margins with high per-unit-sold metrics. Therefore, there is a need for an automated, accurate, and precise design system that supports advanced manufacturing techniques, results in lower cost-per-unit-sold metrics, and provides an agile design cycle that can respond to rapid changes in market demand.

Other methods of apparel design and manufacturing may often rely on linear standard sizing systems based on unrealistic measurement of the ‘ideal body,’ which do not account for the unique variations in individual body shapes. This one-size-fits-all approach may lead to ill-fitting apparel, resulting in discomfort for the wearer and increased rates of returns for retailers. For example, issues pertain to the limited range of apparel sizes attributable to sizing methodologies, such as bust-waist-hip proportions. Patterns may only be linearly scaled up, a method that may quickly reach its limitations as distortion occurs beyond certain thresholds, restricting the capability to cater to a broader consumer base. Additional sizes may not be produced without substantial redesign efforts, requiring specialized knowledge for larger sizes. Consequently, a vast demographic remains underserved in the apparel market.

Interoperability between different software tools and platforms also plays an important role in automating garment manufacturing. Each system often uses file formats that are not compatible with other systems, leading to inefficiencies and errors when transferring data. This lack of standardization may hamper collaboration and innovation within the industry. Interoperability between different apparel software systems may be challenging due to non-standardized and poorly documented pattern file formats, including missing measurement. Each software system may implement architecture-specific changes, further complicating the sharing and adaptation of patterns across platforms. This limitation may restrict collaboration among designers using varied software tools and inhibits the efficient scaling of design processes. Furthermore, pattern files may lack design engineering data or may be missing manufacturing information, which hinders reusability and editability. As a result, designers may face challenges in modifying or remixing patterns and may compromise the designs in the modification process.

Certain apparel design technologies may not incorporate advanced computational methods, such as machine learning (ML) and artificial intelligence (AI), to the full potential of such methods. While attempts have been made to integrate ML and AI technologies, they may often be used superficially and do not fundamentally change the garment design and production processes. For example, other knowledge bases used to train generative AI systems may fail to encapsulate best practices for apparel characteristics in an object-oriented manner. Consequently, designs generated through AI, such as those developed via voice prompts, may result in patterns lacking manufacturability due to insufficient engineering information. Without an adequate knowledge base, AI-generated patterns may not align with the physical parameters required for successful wearability.

There is a continuing need for a technology that addresses these shortcomings in the apparel industry. Desirably, such a system would automate the pattern adaptation process to accommodate changes in styles, markets, sizes, body shapes, and individual body measurement efficiently, facilitate interoperability among different design platforms, and effectively integrate advanced AI to revolutionize apparel design and manufacturing. This would not only improve the fit and satisfaction of the end consumer but also enhance the operational efficiency and adaptability of the apparel industry.

### SUMMARY

In concordance with the instant disclosure, ways to automate the pattern adaptation process to accommodate changes in styles, markets, sizes, body shapes, and individual body measurement efficiently, facilitate interoperability among different design platforms, and effectively integrate advanced AI to revolutionize apparel design and manufacturing, have surprisingly been discovered. The present technology includes articles of manufacture, systems, and processes that relate to the automated generation and customization of apparel patterns using advanced computational techniques, including machine learning (ML) and artificial intelligence (AI), to enhance the fit, scalability, agility, and interoperability of garment design across various platforms and manufacturing systems.

In certain embodiments, a system for generating a parametric formula for a user from an image and measurement is provided. The system may include a processor and a memory in communication with the processor. The memory may include a receiving module, an AI module, a conversion module, a validation module, a generation module, and an application interface module. The memory may include an analysis module and a storage database. The receiving module may receive the image, the measurement corresponding to the image. The receiving module may receive a technical packet “tech pack” document containing manufacturing information composed of text and graphics conveying product, sizing, materials, and construction information. The system may include a storage database to store the image, the measurement, the 3D avatar, the manufacturing information, and parametric formula templates. The AI module may identify a pattern feature such as a pattern landmark, a seam, a notch, a dart, or other symbol or object. The conversion module may convert the measurement to a measurement file and a 3D avatar. The generation module may receive the image, the pattern feature, the measurement file, and the 3D avatar and generate the parametric formula that receives a parametric input and may generate a structured parametric CAD file including measurement corresponding with the parametric formula. The validation module may validate the measurement file, the 3D avatar, the parametric formula, and the structured parametric CAD file. The memory may also include a manufacturing module to export the parametric formula and manufacturing information to a manufacturing instruction that is appended to the parametric CAD file. The manufacturing instruction may include information on a fabric type, a seam style, a rate of fabric shrinkage, and may be represented in the CAD file hierarchical object orientation. The application interface module may display the image, the measurement, the measurement file, the 3D avatar, the parametric formula, the structured parametric CAD file, and the manufacturing instruction. The manufacturing instruction may instruct a manufacturing device or manufacturing system in creating an apparel. The manufacturing device or manufacturing system may receive the manufacturing instruction in the parametric CAD file from the manufacturing module or the application interface module, process the manufacturing instruction with the device or system application programming interface (API), and manufacture apparel according to the processed manufacturing instruction.

In certain embodiments, a method for generating a parametric formula for a user from an image and measurement is provided. The method may include a step of providing a processor, a memory in communication with the processor. The memory may include a receiving module, an AI module, a conversion module, a validation module, a generation module, an application interface module. The memory may also include an analysis module, and database. The AI module may identify a pattern feature in the image such as a pattern landmark, a scam, a notch, a dart, or other symbol or object. The conversion module may convert the image and the measurement to a measurement file and a 3D avatar. The generation module may receive the pattern feature, measurement file, and the 3D avatar and generate the parametric formula that receives parametric input. The generation module may create a structured parametric CAD file containing the parametric formula and manufacturing instructions and require a measurement file as parametric input and may allow additional measurement files and 3D avatars to be created through upload and conversion of ready-to-wear sizing measurements and measurements of an individual, and through communication with the application programming interface (API) of 3D body scanning or other application. The validation module may validate the measurement file, the 3D avatar, the parametric formula, and the structured parametric CAD file. The application interface module may receive input data from websites, desktop applications, smartphone applications, and other applications and platforms. The application interface module may display the image, the measurement, the measurement file, structured parametric CAD file, the 3D avatar, the parametric formula, and the manufacturing instructions in 2D, 3D, AR, VR, and other mixed reality formats via monitors, projectors, headsets, and other display devices to the user and allow user interactions via keyboard, mouse, game controllers, haptic devices, and other input devices.

The method may include a step of receiving the image and the measurement corresponding to the image via the receiving module. For example, the image as a digitization of an apparel pattern, a set of coordinate points that outlines an apparel pattern, an illustration, or a photograph. The receiving module may receive a technical packet “tech pack” document via the receiving module and storing the “tech pack” information to the storage database via the conversion module and transform the stored “tech pack” data into manufacturing instruction via a manufacturing module. The method may include a step of converting the measurements to the 3D avatar and measurements file via the conversion module. The method may include a step of converting the image to pattern features via the conversion module and AI module. The method may include a step of generating the parametric formulas that receive parametric inputs from the pattern features via the generation module and the analysis module. The method may include a step of validating the measurement file and 3D avatar for accuracy via the validation module. The method may include a step of validating the parametric formulas for precision via the validation module. The method may include a step of generating a structured parametric CAD file including measurement corresponding with the parametric formulas using the application interface module. The method may include a step of preparing the parametric CAD file and measurement file, and notifying the user via the application interface module. The parametric CAD file 208 and measurement file 198 may be prepared to be downloaded by the user. The parametric CAD file 208 and measurement file 198 may also be delivered to the user.

In certain embodiments, the method for generating a parametric formula for a user from an image and measurement may include a step of receiving the image in 2D or 3D formats, such as JPG, PNG, PDF, DXF, OBJ, or glTF. The method may include a step of receiving the measurement in a text file format associated with the image. The method may include a step of receiving a tech pack document in combined text and graphics format associated with the image. The method may include a step of converting the tech pack document to pattern features via the AI module and the conversion module.

In certain embodiments, the method for generating a parametric formula for a user from an image and measurement may include a step a of generating the parametric formula to include a fabric type, a seam style, or a rate of fabric shrinkage, for example, derived from “tech pack” data stored in the database. The method may include a step of structuring a parametric formula via object orientation in a hierarchical data structure. The method may include a step of providing a storage database to store the image, parametric formulas, and the measurements for use in another parametric formula. For example, the storage database may store the tech pack.

In certain embodiments, the method for generating a parametric formula for a user from an image and measurement may include a step of generating a 3D mesh format pattern from the parametric CAD file and measurements file. The method may include a step of displaying the 3D mesh pattern on the 3D avatar via the application interface module. The method may include a step of updating the 3D mesh pattern via user input using the application interface module. The method may include a step of updating the parametric CAD file to match updates in the 3D mesh pattern via the application interface module.

In certain embodiments, the method for generating a parametric formula for a user from an image and measurement may include a step of providing in the memory a manufacturing module to export the parametric formula to a manufacturing instruction. The method may include a step of providing a manufacturing device to receive the manufacturing instruction from the manufacturing module and manufacture the apparel according to the manufacturing instruction. The method may include a step of exporting the parametric formula to the manufacturing instruction to instruct a manufacturing device in creating an apparel. The method may include a step of receiving the manufacturing instruction via the manufacturing device from the manufacturing module. The method may include a step of operating the manufacturing device to create the apparel according to the manufacturing instruction.

Advantages of the present technology include the implementation of agile and efficient apparel design workflows and parametric formulars that minimize or eliminate the need for manual steps in pattern making. The parametric formula may enhance the creation of editable and reusable patterns due to the incorporation of constraints that prevent errors, enhancing reliability and usability. The present technology may achieve interoperability between different systems as the parametric formula may generate an image of the pattern that may be exported in any format, accommodating specialized data from various systems. The present technology may enable an AI module that may allow for apparel product designs to be manufactured across a wide range of manufacturing devices, paving the way for advanced, technology-driven fashion design. Aspects provided herein may also include the capability to generate an extended range of sizes from each pattern without additional cost or effort, allowing brands to cater to niche markets and to offer designs in an inclusive range of sizes.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a block diagram illustrating a system, according to some embodiments of the present disclosure;

FIG. 2A is a block diagram illustrating aspects of a receiving module, according to some embodiments of the present disclosure;

FIG. 2B is a block diagram illustrating aspects of a receiving module and a technical packet (tech pack), according to some embodiments of the present disclosure;

FIG. 3 is a block diagram illustrating aspects of a database, according to some embodiments of the present disclosure;

FIGS. 4A and 4B are block diagrams illustrating aspects of a receiving module, according to some embodiments of the present disclosure;

FIGS. 5A-5C are block diagrams illustrating aspects of a conversion module, according to some embodiments of the present disclosure;

FIG. 6 is a block diagram illustrating aspects of a validation module, according to some embodiments of the present disclosure;

FIG. 7 is a block diagram illustrating aspects of a generation module, according to some embodiments of the present disclosure;

FIGS. 8A and 8B are block diagrams illustrating aspects of a validation module, according to some embodiments of the present disclosure;

FIG. 9 is a block diagram illustrating aspects of a manufacturing module, according to some embodiments of the present disclosure;

FIGS. 10A and 10B are block diagrams illustrating aspects of an application interface module, according to some embodiments of the present disclosure;

FIGS. 10C-10D are illustrations of the base size 3D avatar and different sizes of ‘test case’ 3D avatars, according to some embodiments of the present disclosure;

FIGS. 11A-11C are illustrations of a 3D design environment, according to some embodiments of the present disclosure;

FIGS. 12A-12B provide a flowchart illustrating a method for generating a parametric formula for a user from an image and measurement, according to some embodiments of the present disclosure;

FIG. 13 is a flowchart extending from FIGS. 12A and 12B and further illustrating the method for receiving an image and a measurement, and providing an analysis module, according to some embodiments of the present disclosure;

FIG. 14 is a flowchart extending from FIGS. 12A and 12B and further illustrating the method for generating and structuring a parametric formula and proving a storage database, according to some embodiments of the present disclosure; and

FIG. 15 is a flowchart extending from FIGS. 12A and 12B and further illustrating the method for providing a 3D design environment in the application interface module, according to some embodiments of the present disclosure.

FIG. 16 is a flowchart extending from FIGS. 12A and 12B and further illustrating the method for a manufacturing module and manufacturing device, according to some embodiments of the present disclosure.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

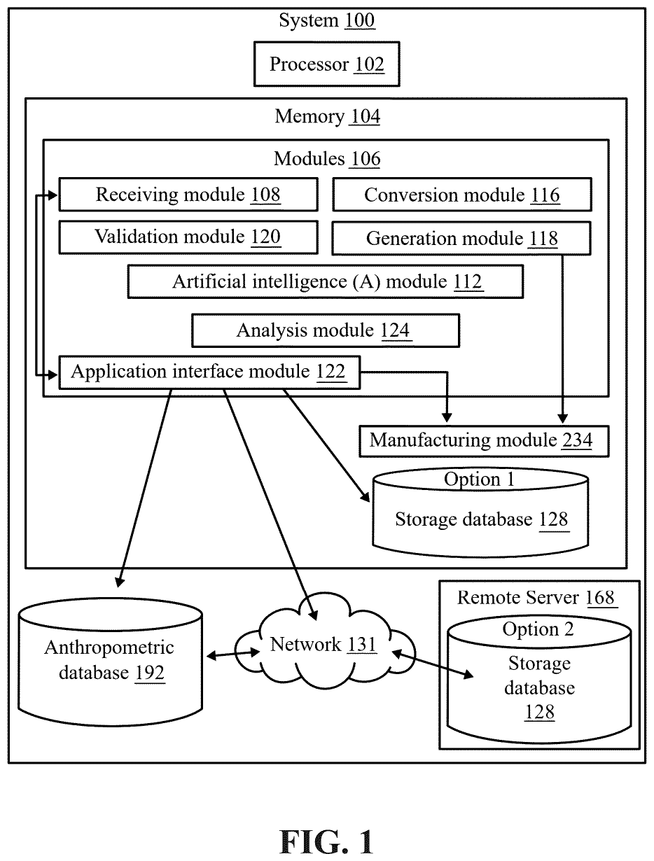

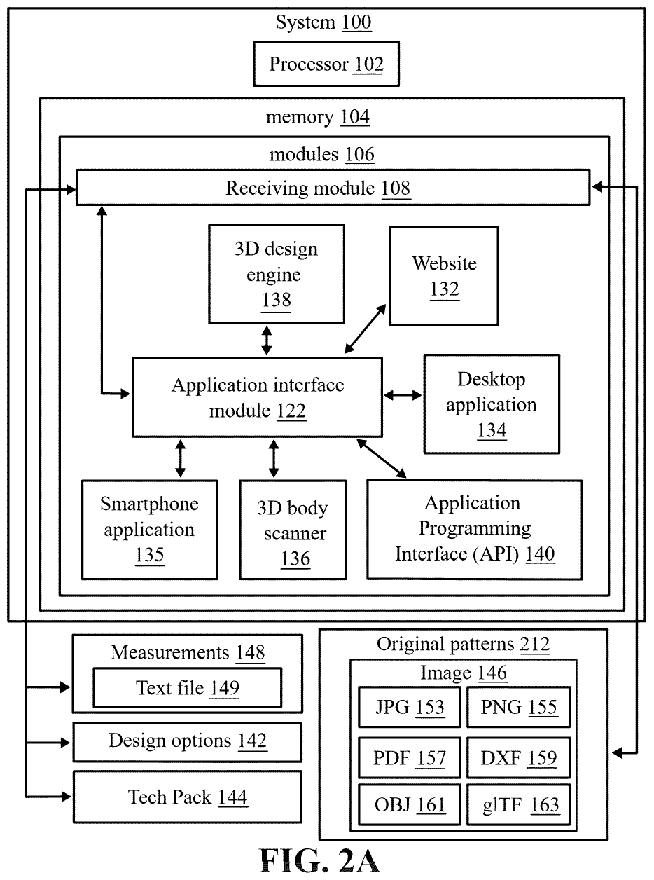

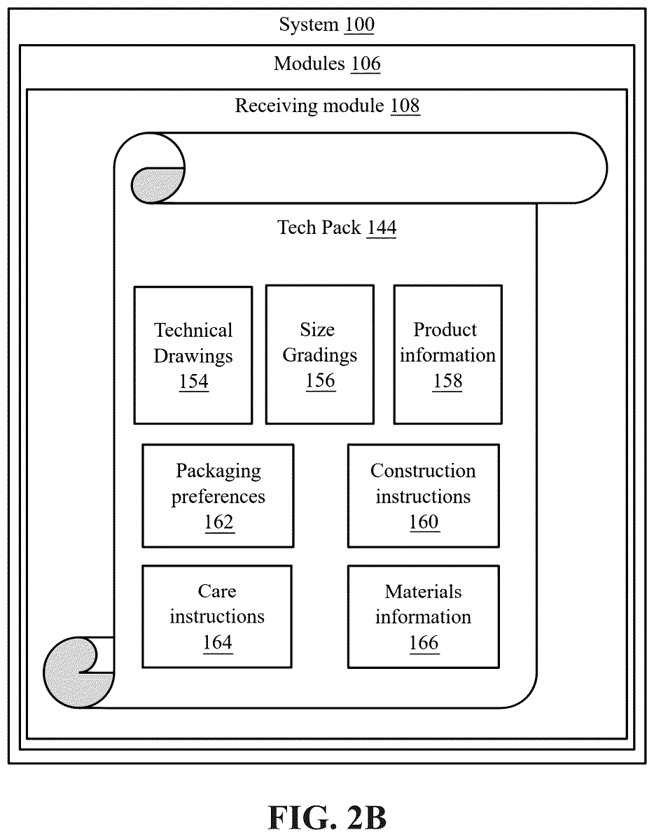

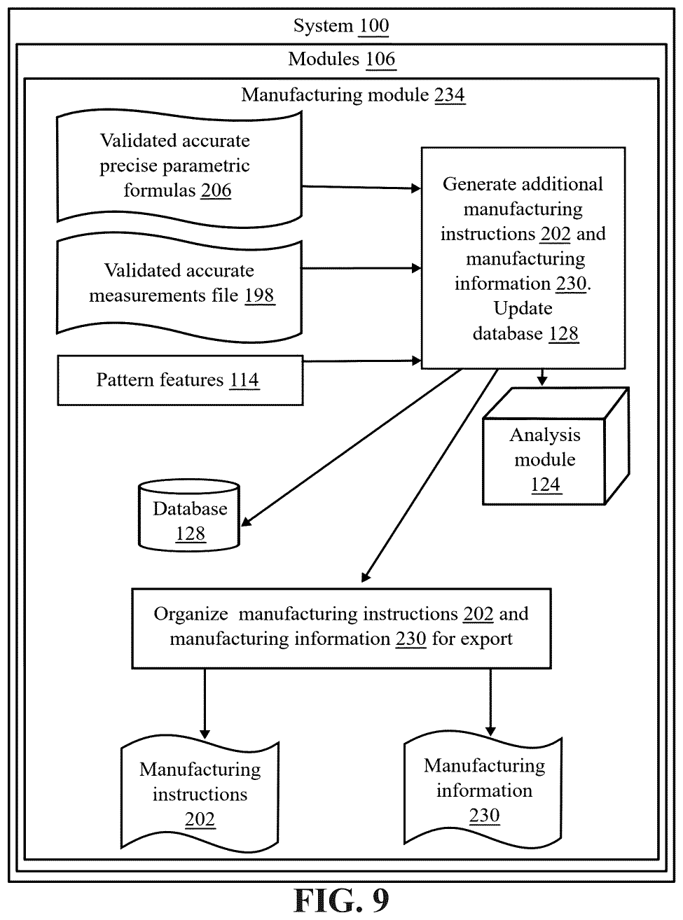

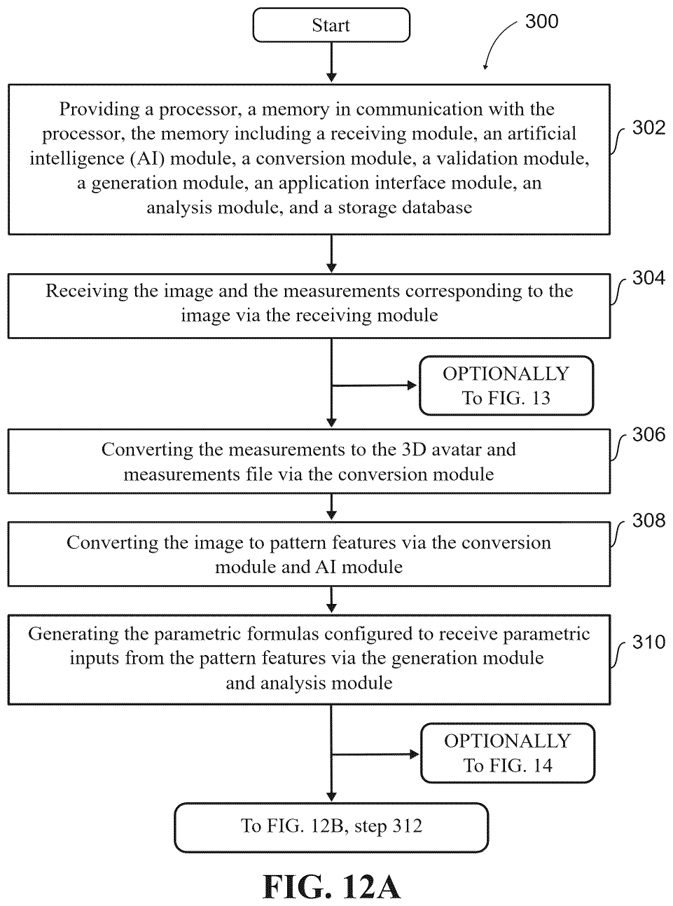

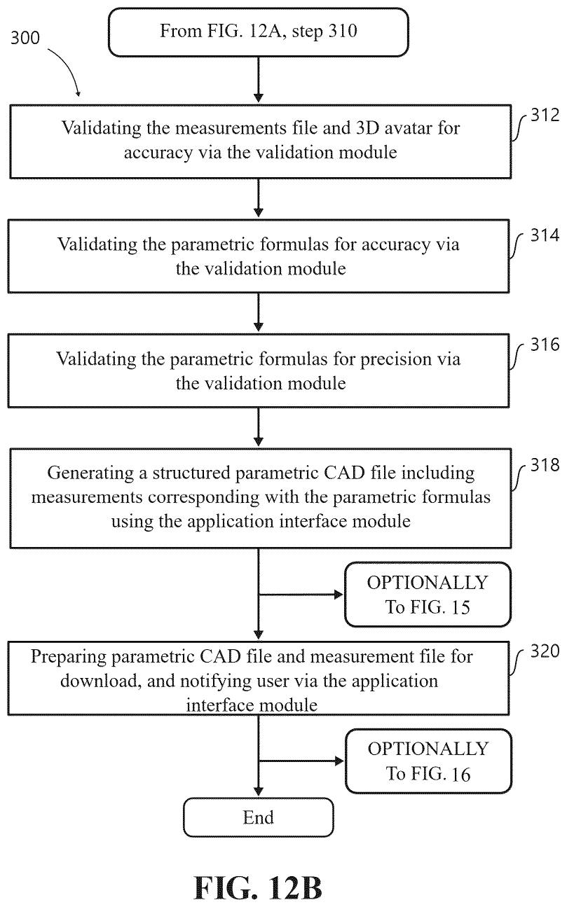

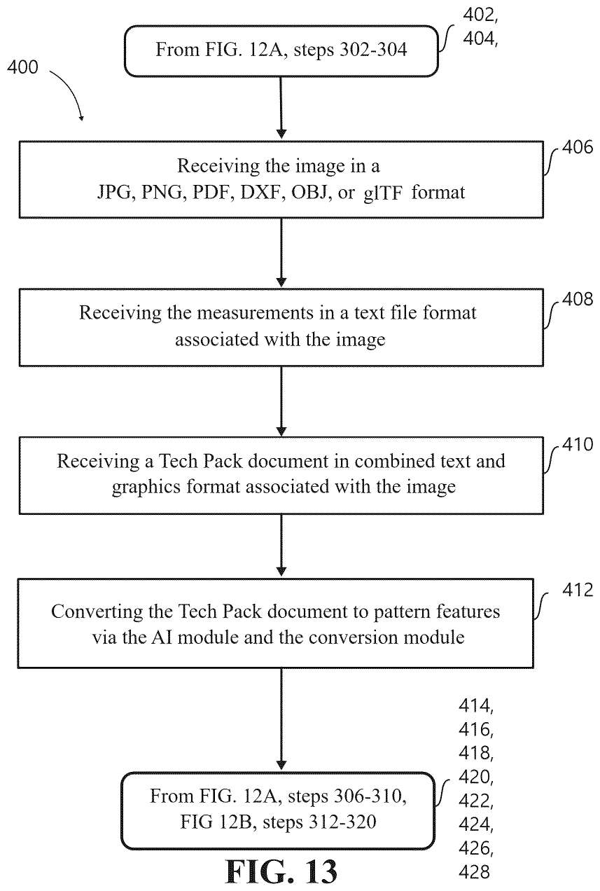

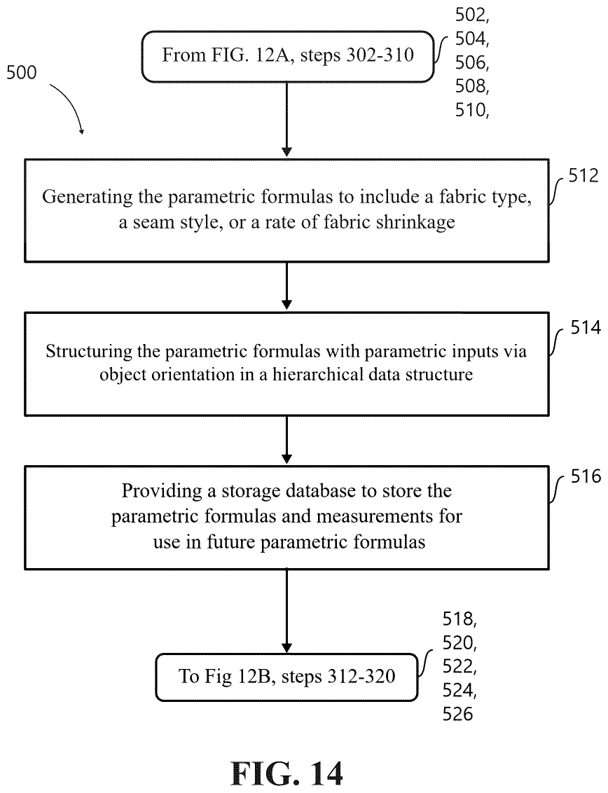

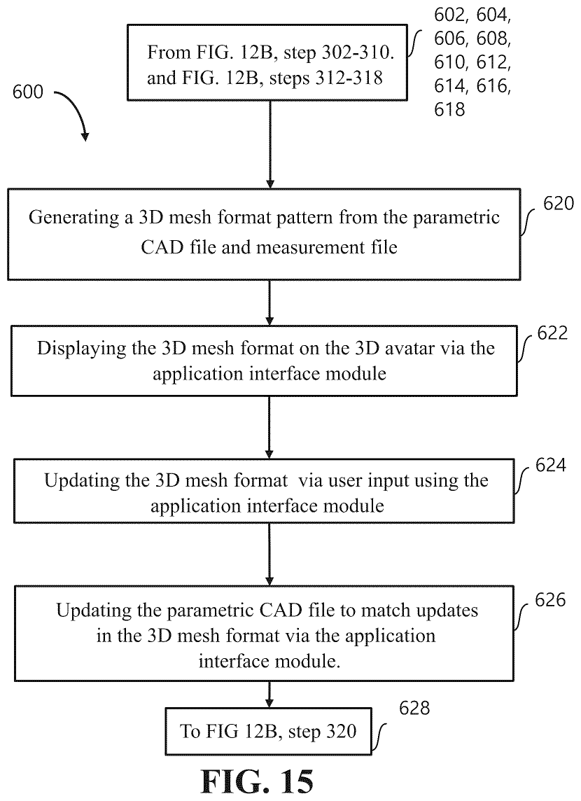

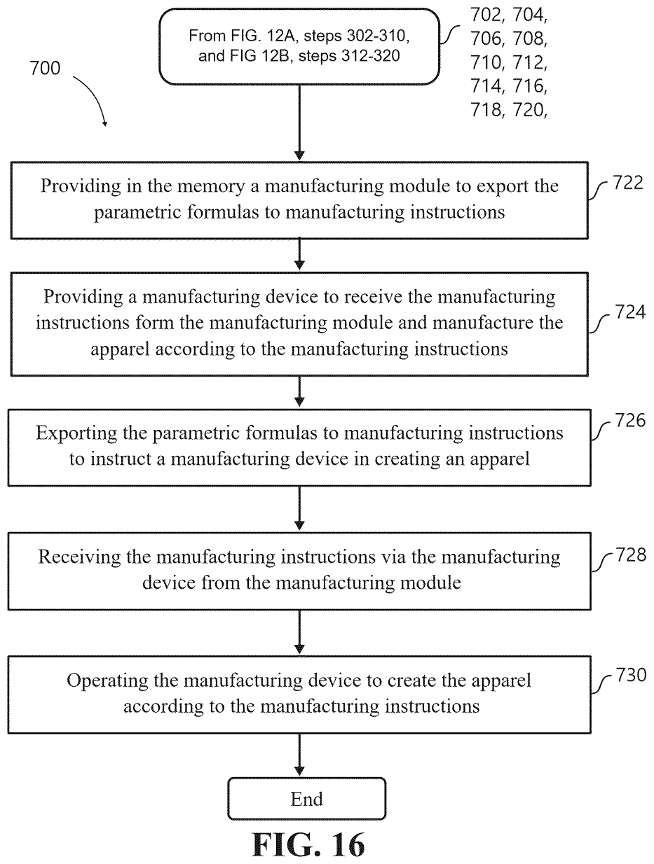

The present technology improves efficiency, accuracy, and customization of apparel manufacturing by using artificial intelligence (AI) to convert a standard apparel pattern and apparel design information into a structured computer-aided design (CAD) based parametric pattern and display the actual fit of digital apparel products on consumer avatars, thus improving industry outcomes. The present technology also enhances interoperability among different design and manufacturing platforms, facilitating seamless data integration and collaboration across the apparel industry. By streamlining the design workflow with AI and enabling rapid scaling of a pattern to a wide range of sizes without manual intervention, the present technology addresses industry challenges of reducing production time, minimizing waste, and meeting the diverse sizing needs of the global consumer base. Specifically, the present disclosure may relate to a system 100 for generating a parametric formula, aspects of which are shown generally in accompanying FIGS. 1-11C. A method 300 for generating a parametric formula is also disclosed in FIGS. 12A and 12B. Another method 400 for generating a parametric formula is disclosed in FIG. 13. Another method 500 for generating a parametric formula is disclosed in FIG. 14. Another method 500 for generating a parametric formula is disclosed in FIG. 14. Another method 600 for generating a parametric formula is disclosed in FIG. 15. Yet another method 700 for generating a parametric formula is disclosed in FIG. 16.

As shown in FIGS. 1-16, the system 100 and methods 300, 400, 500, 600, and 700 allow a user to generate a parametric formula 206. The system 100 may include a processor 102, and a memory 104 in communication with the processor 102. The memory 104 may include modules 106 that facilitate various functions of the system 100, including a receiving module 108 for receiving and preprocessing input data 110. The memory 104 may include an AI module 112 for identifying a pattern feature 114. The memory 104 may include a conversion module 116 for processing input data 110. The memory 104 may include a generation module 118. The memory 104 may include a validation module 120. The memory 104 may include an application interface module 122. The memory 104 may include an analysis module 124 to receive the input data 110 to store in a storage database 128 and to analyze for a new pattern piece 130.

The processor 102 may be located on a local system 100 or a remote system 100 server accessed via a network 131. The remote system 100 server may be the central hub of the system 100, containing the processor 102 and memory 104 that store and execute the modules 106 necessary for processing input data 110. One skilled in the art will also appreciate that the processor 102 may include one or more processors 102 and may process information and executing instructions or operation. For example, the processor 102 may include a central processing unit (CPU), a microprocessor 102, a microcontroller, or a system 100-on-a-chip, a digital signal processor 102 (DSPs), field-programmable gate arrays (FPGAs), application-specific integrated circuits (ASICs), or processors 102 based on a multi-core processor 102 architecture. One or more processors 102 may mean a single processor 102 or multiple processors 102 in a single processing unit, e.g., a central processing unit, or multiple processing units, e.g., a central processing unit and a graphics processing unit, or a central processing unit and a memory 104 manager. The processor 102 may include multiple processors 102 where one processor 102 is capable of executing one or more of the elements described in this disclosure, and a subsequent processor 102 or processors 102 may execute other elements as described herein, capable of executing all elements only in combination. One or more of the processors 102 may be remote from the at least one system 100 server.

The memory 104 may store or otherwise include a plurality of databases 128. The memory 104 can be one or more memories 104 and of any type suitable to the local application environment and can be implemented using any suitable volatile or nonvolatile data storage technology such as a semiconductor-based memory 104 device, a magnetic memory 104 device and system 100, an optical memory 104 device and system 100, fixed memory 104, and removable memory 104. For example, the memory 104 can consist of any combination of random-access memory 104 (RAM), read only memory 104 (ROM), static storage such as a magnetic or optical disk, hard disk drive (HDD), or any other type of non-transitory machine or computer readable media.

Referring now to FIGS. 1-2B, and 4A-4B, the receiving module 108 may receive input data 110 for pre-processing. For example, user may upload the input data 110 to the receiving module 108 via a website 132, desktop application 134, smartphone application 135, 3D body scanner 136, 3D design engine 138, or another design and product development software tool 238. Alternatively, the user may upload the input data 110 via an Application Programming Interface (API) 140 in communication with the receiving module 108. For example, the receiving module 108 may also accept a design option 142 from the user to enable customization and personalization of the input data 110. The receiving module 108 may save the input data 110 to a storage database 128 for further processing. Pre-processing the input data 110 may include transforming, scaling and normalizing the input data 110 for use in the AI module 112. The receiving module 108 may also accept a technical package (tech pack) 144 from the user containing illustrations, descriptions, and manufacturing data. It should be appreciated that saving the input data 110 to a storage database 128 via the receiving module 108 may also allow for building a dataset for training the AI module 112 and expanding future design options 142.

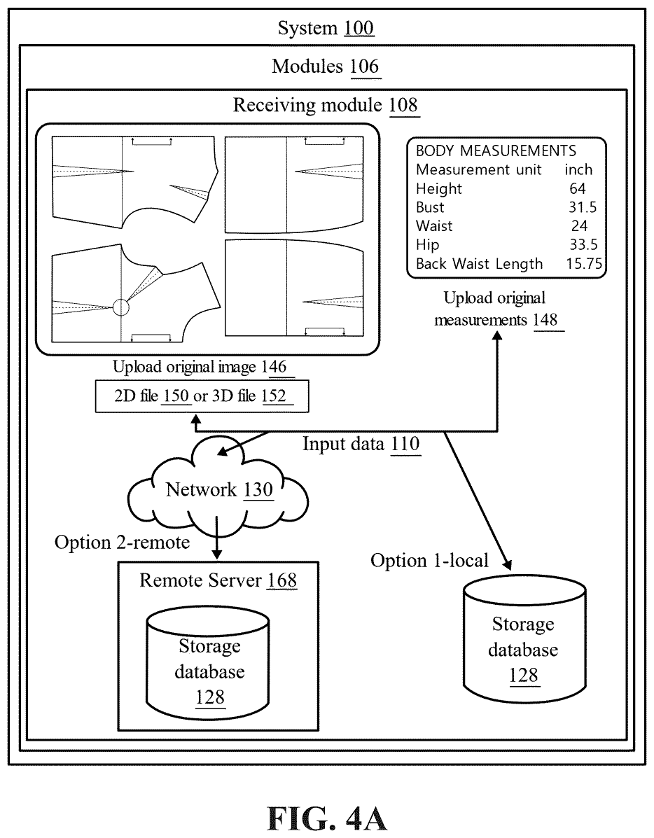

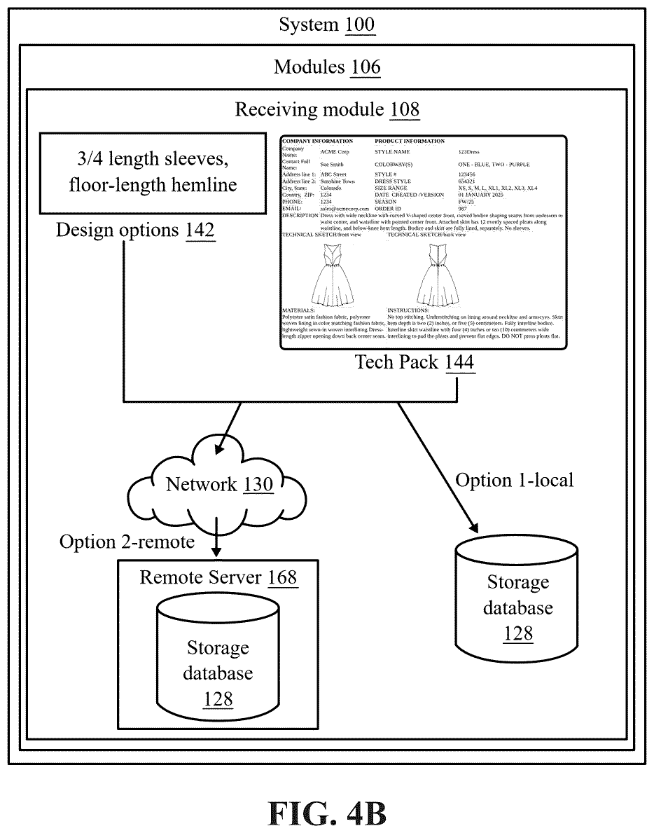

As shown in FIGS. 4A and 4B, input data 110 may include an image 146 or measurement 148. For example, the input data 110 may be uploaded by a user via the receiving module 108 as a file, a data stream, as an input field in a digital form, in an email application workflow, a short message service (SMS) or text communication, or the like, and may be uploaded to the receiving module 108 through transfer methods including wired transfer, wireless transfer, or any other data communication protocol and protocol stack. The user may upload the input data 110 in various file types, for example, a text file 149, text from a textbox, an image 146, a photograph, or an illustration of an apparel 236. The user may upload the input data 110 in the form of body measurement 148, for example, measurement 148 taken manually with a tape measure, measurement 148 taken using a body scanning application, or a base size measurement 148 from a company or brand. In another example, the user may upload input data 110 as a text description 191 of the image 146 or the measurement 148, such as providing text prompts using a form of AI such as an AI chat bot to generate a design option 142. The input data 110 may be uploaded as a two-dimensional (2D) file 150 or three-dimensional (3D) file 152. For example, the file format of the image 146 may include a Joint Photographic Experts Group file (JPG) 153, a portable network graphic (PNG) 155, a portable document format (PDF) 157, a Drawing Interchange Format (DXF) 159, an object file (OBJ) 161, a graphics library transmission format (glTF) 163, a tech pack 144, raster format, vector format, or the like. The tech pack 144 may include comprehensive documentation used in manufacturing to communicate all the technical details of a product to a manufacturer, ensuring accurate production, including a technical drawing 154 depicting flat sketches of garments from multiple angles showing construction details and design elements, precise measurement 148 for each part of the garment including a size grading 156 to ensure proper fit, product information 158 showing cost and quantity of a material, a construction instruction 160 on how the garment should be constructed, (e.g. stitching, hemming, and finishing details, specific color references for fabrics, trims, and other elements to maintain consistency, such as a logo or tag), and a packaging preference 162. The tech pack 144 may also include a care instruction 164, for example, an instruction for washing, drying, and ironing. The tech pack 144 may also include materials information 166.

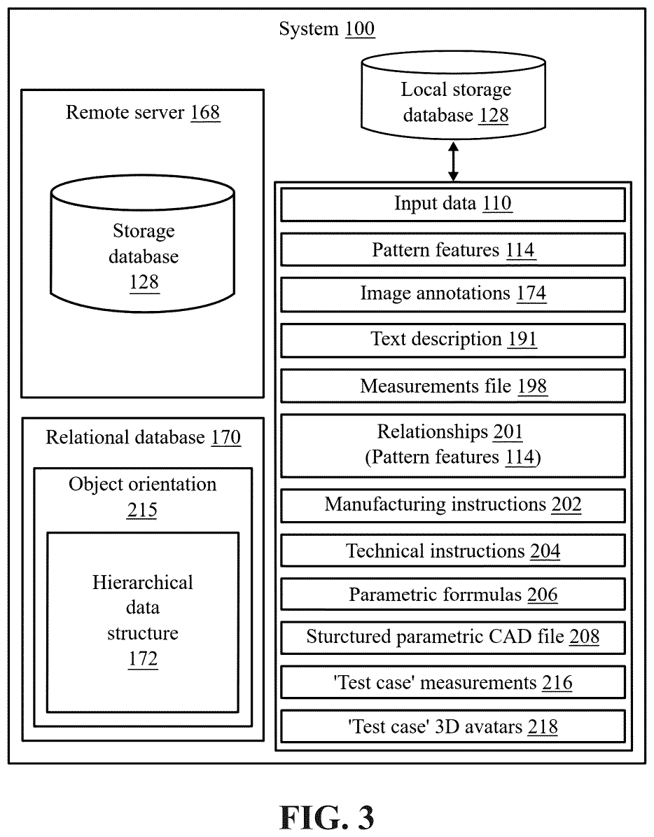

Referring now to FIG. 3, the storage database 128 may include a local database 128, a database 128 saved on a remote server 168 and accessed via a network 131, such as cloud server, or a combination local and remote storage database 128 as required by the system 100. The storage database 128 may include a relational database 170, for example, MySQL, MariaDB, PostgreSQL, or Microsoft SQL. The storage database 128 may, for example, may include a vector database to store vector embeddings. The storage database 128 may save a new pattern piece 130, pattern feature 114, design option 142, or other processed information into a relational database 170 or other data structure. It should be appreciated that the relational database 170 may capture a design option 142, new pattern piece 130, or pattern feature 114 in a hierarchical data structure 172 for use in another design option 142 or an individual new pattern piece 130.

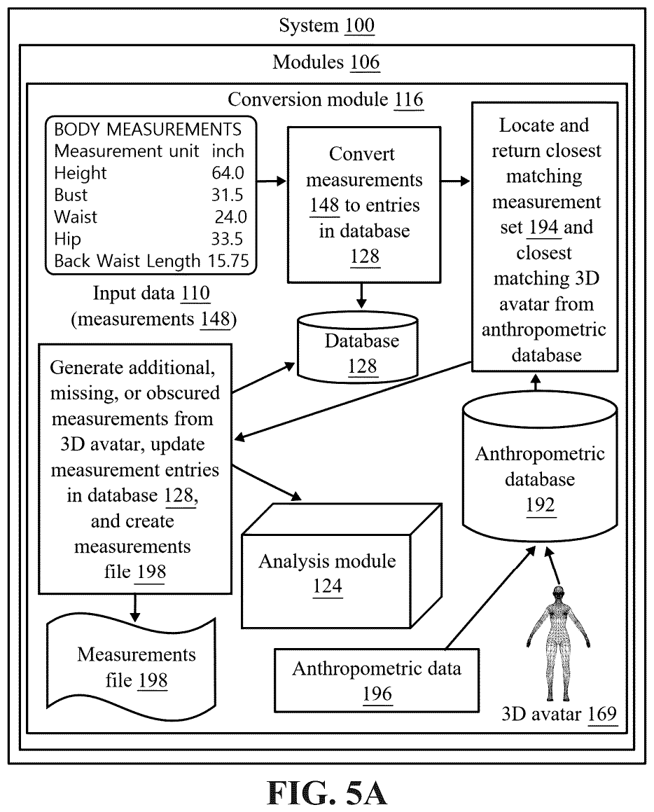

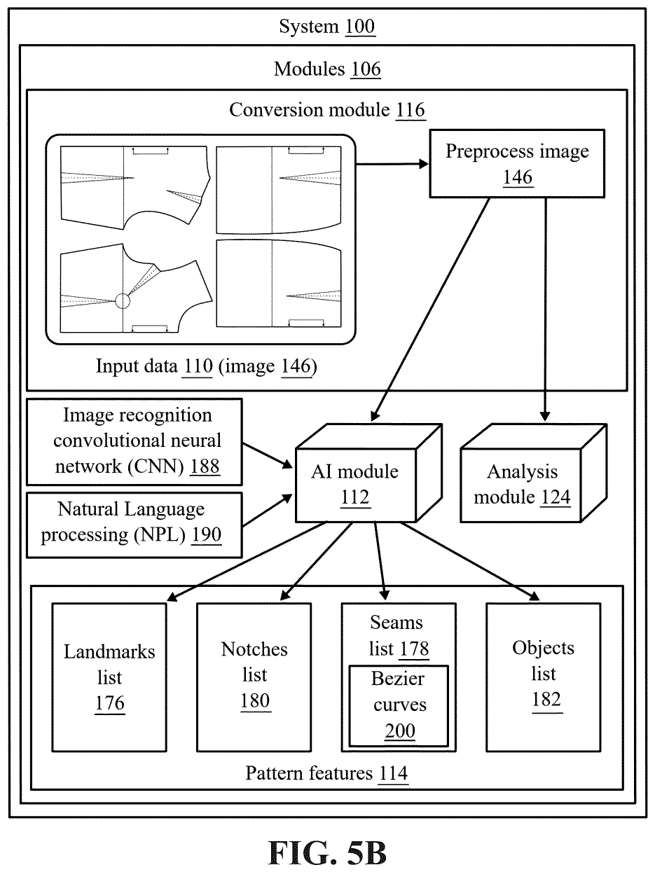

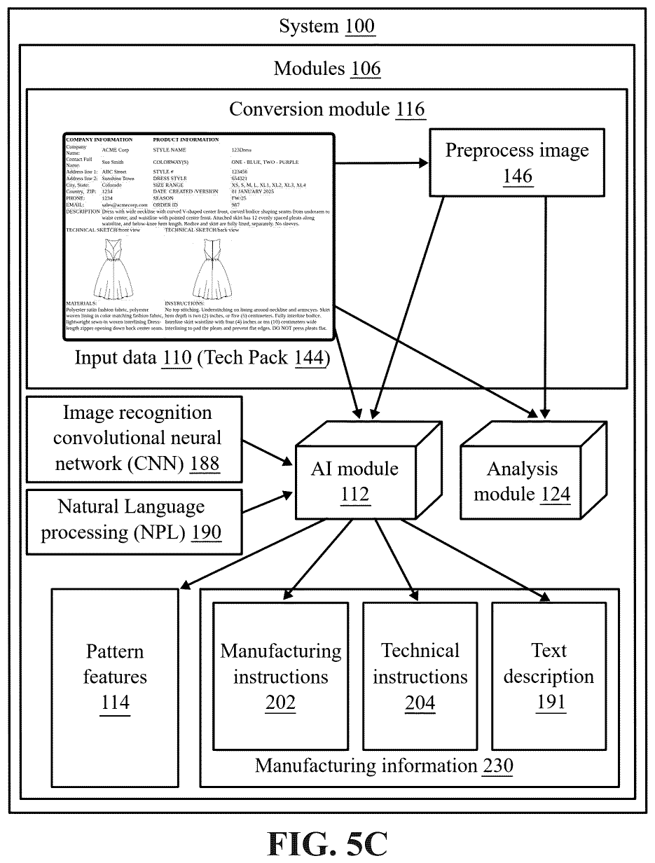

As shown in FIG. 5B, the AI module 112 may identify and annotate an apparel image 146 uploaded by the user. Specifically, the AI module 112 may generate an image annotation 174 by classifying a pattern feature 114. For example, the AI module 112 may be trained to identify pattern categories, pattern piece categories, pattern labels, pattern piece labels, or rulesets for pattern pieces (e.g. ‘waistband’, ‘pants leg’, ‘zipper fly’, ‘skirt panel’, ‘sleeve’, ‘collar stand’, ‘collar’, etc.) The AI module 112 may segment, localize, and classify the pattern feature 114 including a landmark 176, seam 178, notch 180, or other object 182 such as a symbol or dart and place the pattern feature 114 into lists. It should be understood that the AI module 112 may identify a plurality of pattern features 114. For example, the AI module 112 may be trained to detect points of discontinuity of a pattern feature 114 and a landmark 176. Additionally, the AI module 112 may be trained to classify seam 178 features, for example, lines and curves. When a tech pack 144 is uploaded by the user to the receiving module 108, the AI module 112 may parse and organize the tech pack 144 (e.g. create free-form text and illustrations) for processing. It should be appreciated that the AI module 112 may be periodically trained and fine-tuned with the input data 110 to identify a wide range of pattern features 114. The AI module 112 may also use image recognition with a convolutional neural network (CNN) 188 to identify illustrations in an image 146 and save the identified illustrations to the storage database 128. The AI module 112 may also use natural language processing (NPL) 190 to identify a text description 191 of an image 146 or pattern feature 114 and store the identified text description 191 in the storage database 128. For example, a user may provide a text description 191 in the form of a text prompt for the AI module 112 to generate the appropriate parametric formula 206 and measurement file 198. The AI module may also The AI module 112 may provide recommendations to the user based on the image 146, measurement 148, parametric formula 206, or text description 191.

As illustrated in FIGS. 5A-5C, the conversion module 116 may process input data 110 in the form of an image 146, or input data 110 that includes measurement 148, or input data 110 that includes “tech pack” 144. For input data 110 that includes incomplete measurement 148, the conversion module 116 may provide, supplement, or replace missing or obscured measurement 148. To fit the image 146 with the measurement 148, the conversion module 116 may access and search an anthropometric database 192 to find and retrieve a closest matching measurement 148 and a closest matching 3D avatar 169. The anthropometric database 192 may include a database 128 that stores information on human body size and shape and may be the basis upon which a digital human model, including a 3D avatar 169. The anthropometric database 192 may include databases 128 such as the National Health and Nutrition Examination Survey (NHANES), the 1988 U.S. Army Anthropometry Survey (ANSUR), the 2015 U.S. Army Anthropometry Survey (ANSUR II), or the Civilian American and European Surface Anthropometry Resource (CAESAR). The anthropometric database 192 may contain data from a 3D body scanner 136 in addition to conventional one-dimensional measurement 148. The conversion module 116 may select a 3D avatar 169 from the anthropometric database 192 by finding a 3D avatar 169 that matches the measurement 148 provided by the user, if a matching 3D avatar 169 exists, or by generating a 3D avatar 169 if a matching 3D avatar 169 does not exist. For example, the conversion module 116 may receive information from a 3D body scanner 136 from the receiving module 108 to create the 3D avatar 169. The conversion module 116 may also generate an additional measurement 148 from the matching 3D avatar 169 in order to render the user provided measurement 148 complete. The measurement 148 may be used to save the measurement 148, along with any other sizing and anthropometric data 196 in a structured measurement file 198 via the conversion module 116. The measurement file 198 may include, for example, a Seamly2D measurement file 198 (SMIS).

The conversion module 116 may process input data 110 in the form of an image 146 by processing the image annotation 174 from the AI module 112 and storing the image annotation 174 in the storage database 128. For example, the image annotation 174 may be stored in the storage database 128 as results in a company-sensitive pattern relational database 170 or in a hierarchical data structure 172. The conversion module 116 may then calculate the distances between a landmark 176 and another pattern feature 114. The conversion module 116 may calculate seam 178 lengths for each new pattern piece 130. The conversion module 116 may also calculate a quadratic Bezier curve 200 for accurate representation of how the measurement 148 should fit the 3D avatar 169. For example, the conversion module 116 may calculate a Bezier curve 200 for use as a control point for a length and angle of measurement 148.

The conversion module 116 may create a relationship 201 between pattern features 114 and store the relationship 201 in the storage database 128. For example, the conversion module 116 may utilize information such as a technical drawing 154 or a size grading 156 provided by the user-uploaded tech pack 144 to create pairs of new pattern pieces 130. For example, the conversion module 116 may use the tech pack 144 to create a seam 178, notch 180, or another pattern feature 114 within the new pattern piece 130. The tech pack 144 data may be processed by the CNN 188 and the NPL 190 to produce pattern features 114 and manufacturing information 230. The conversion module 116 may also create pairs of placement symbols indicating where the new pattern pieces 130 are to be placed. The conversion module 116 may also create a manufacturing instruction 202 based on the information from the tech pack 144. For example, the conversion module 116 may group information from the tech pack 144 into a manufacturing instruction 202, and pair the manufacturing instruction 202 with a technical instruction 204 that manufacturers will require to create a certain pattern design. Once all the information from the image 146, the image annotation 174, and tech pack 144 are processed, the conversion module 116 may store the processed information including the manufacturing instruction 202 and the technical instruction 204 in the storage database 128, for example, in a relational database 170 or hierarchical data structure 172.

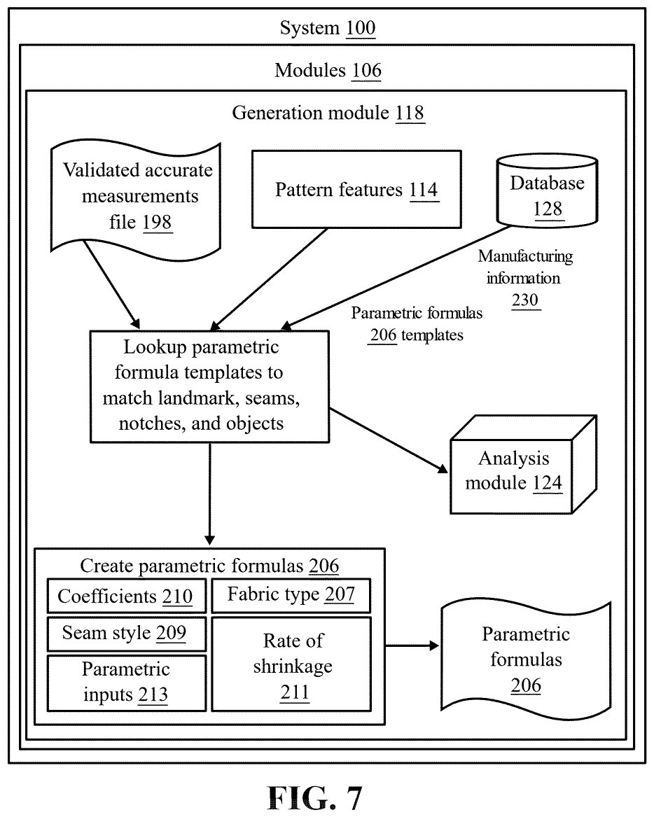

As shown in FIG. 7, the generation module 118 may generate a parametric formula 206 to recreate the input image 146 as pattern pieces into a 2D and 3D structured parametric CAD file 208. The parametric formula 206 may be generated by utilizing information retrieved from an anthropometric database 192 or other pattern design database 128. For example, the generation module 118 may look up a template of a parametric formula 206 in a company-sensitive pattern making database 128. The generation module 118 may customize a parametric formula 206 with a coefficient 210 and other annotation data such as an image annotation 174. For example, the parametric formula 206 may include information for fabric type 207, a scam style 209, or the rate of fabric shrinkage 211. The generation module 118 may structure the parametric formula 206 with a parametric input 213 via object orientation 215 in a hierarchical data structure 172 and store the parametric formula 206 in the storage database 128. It should be appreciated that the generation module 118 may utilize the AI module 112 to annotate the parametric formula 206 to create a comprehensive dataset for manufacturers and retail users.

The generation module 118 may calculate a coefficient 210 by relating the values in the measurement file 198 to the parametric formula 206 retrieved from the storage database 128. The generation module 118 may also update any parametric formula 206 and coefficient 210 with design option 142 data from the storage database 128. Additionally, the generation module 118 may update any manufacturing instruction 202 or manufacturing information 230 as needed, for example, data converted from the tech pack 144. The manufacturing information 230 may include the manufacturing instructions 202, technical instructions 204, and text descriptions 191. Once any required updates are completed, the generation module 118 may store the parametric formula 206 in the storage database 128. The stored parametric formula 206 may be saved in the storage database 128 as a structured parametric CAD file 208. The structured parametric CAD file 208 may include the measurement file 198 as an input, allowing the generation module 118 to replicate an image 146 file as a new image 146 in 2D file 150 or 3D file 152 formats. The generation module 118 may also produce a variety of outputs in human-readable and machine-readable formats, for example, the structured parametric CAD file 208 may include a Seamly2D CAD file format (SM2D).

The generation module 118 may also generate a new pattern piece 130 from the structured parametric CAD file 208, with the input data 110 including a measurement file 198 and an image 146 in a 2D file 150 format or a 3D file 152 format, in order to provide the new pattern piece 130 to the validation module 120. The generation module 118 may also generate a new pattern piece 130 in a 2D file 150 format or a 3D file 152 format from the structured parametric CAD file 208, with the input data 110 including a measurement file 198, along with pre-defined validation test measurement files 198 which have matching 3D avatars 169 to provide to the validation module 120. It should be appreciated that the generation module 118 may include the capability to produce a structured parametric CAD file 208 that can accurately and precisely replicate the input data 110, in the form of an image 146, as a set of new pattern pieces 130 in wide variety of sizes, including custom-sizes in both physical and digital domains, and in both 2D file 150 formats or 3D file 152 formats, where the digital product matches the physical product as a true ‘digital twin.’ For example, the system 100 may include the capability to produce a structured parametric CAD file 208 that may act as a ‘single source of truth’, providing a single ‘digital thread’ from design through manufacturing. For example, the structured parametric CAD file 208 may include information for use in virtual reality (VR), augmented reality (AR) or online meta environments. The generation module 118 may also analyze an original pattern piece 130 and reverse engineering each into a set of reusable, re-editable, and interoperable new pattern pieces 130 that are human-readable and capable of recreating the original pattern piece 130 across a wide variety of sizing requirements that reflect market needs.

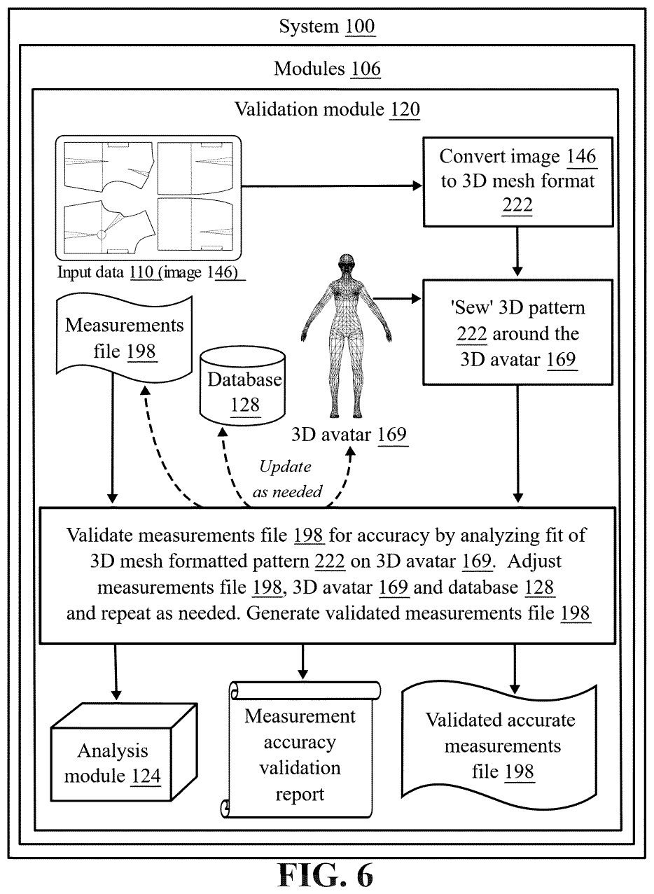

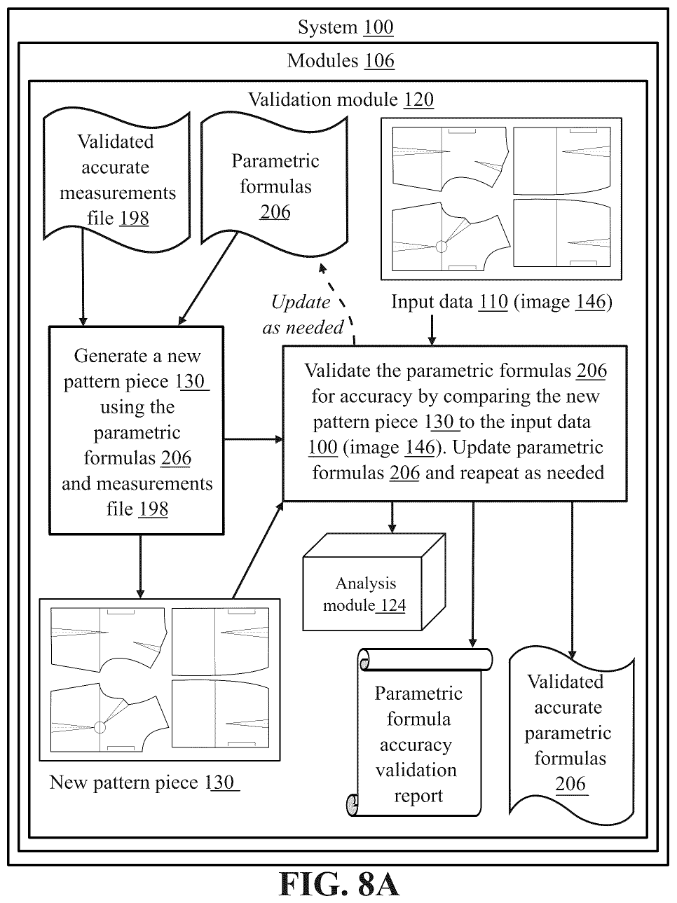

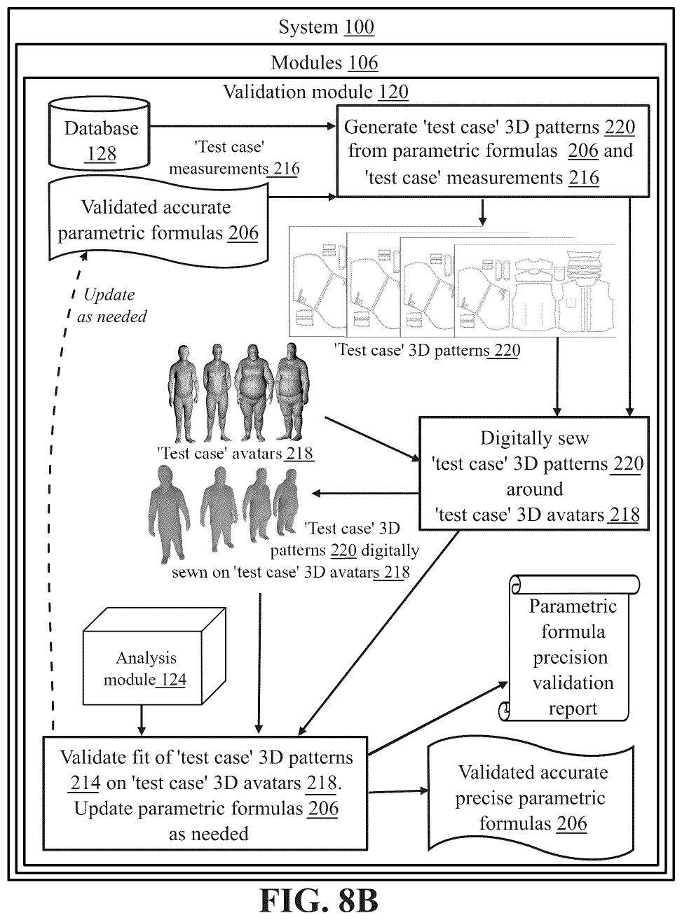

As shown in FIGS. 6, and 8A-8B, the validation module 120 may validate the new pattern piece 130 from the generation module 118 in order to validate for accuracy and for precision. Specifically, the validation module 120 may receive from the generation module 118 a new pattern piece 130 from the structured parametric CAD file 208, and the input data 110 including a measurement file 198 and an image 146 in 2D file 150 formats or 3D file 152 formats. The validation module 120 may compare the new pattern piece 130 with the input data 110 (e.g. image 146) via the AI module 112. If the results of the comparison are outside of a defined margin of error, the validation module 120 may adjust the parametric formula 206 and repeat the validation process as needed.

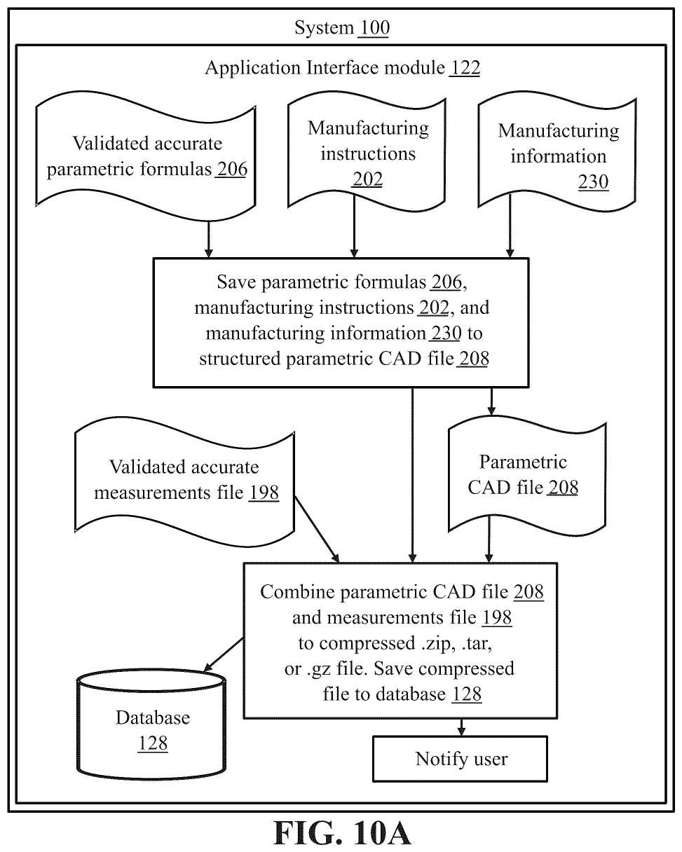

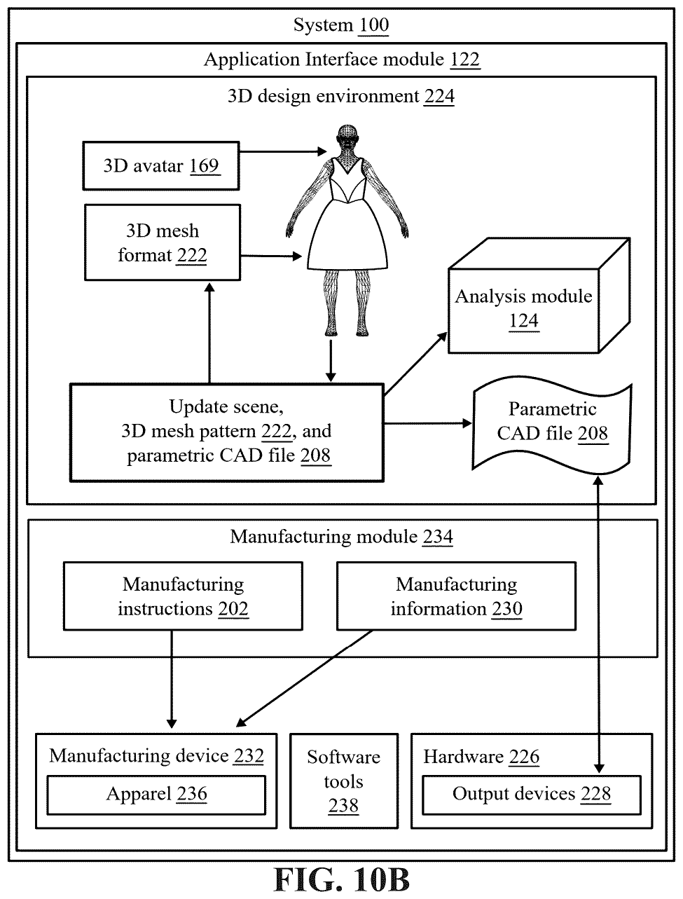

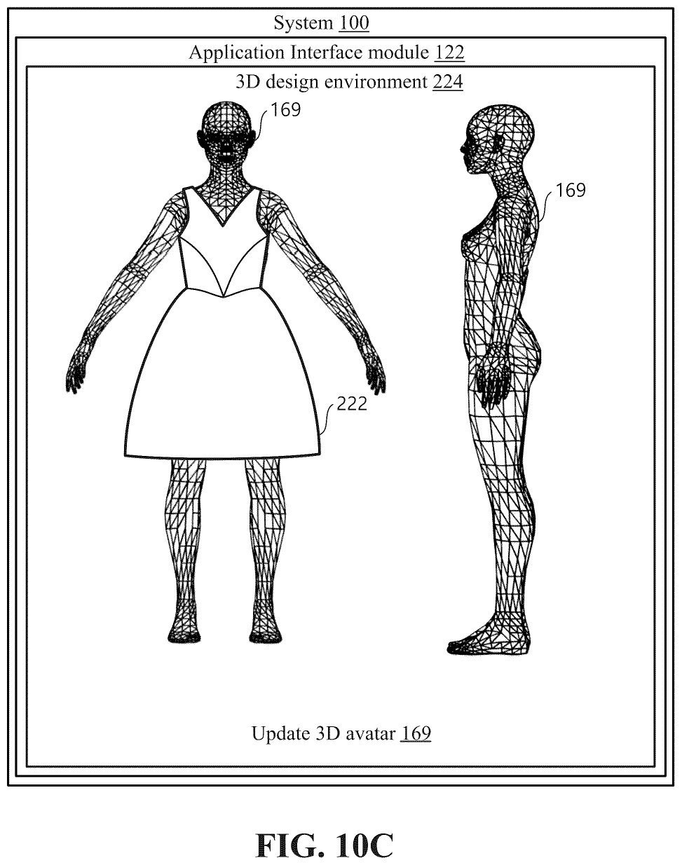

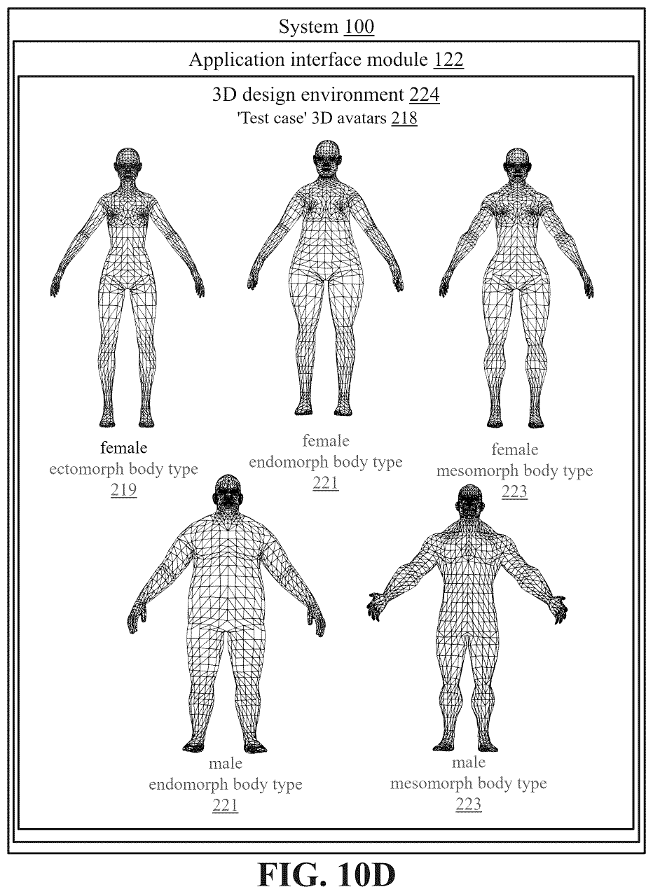

When validating for precision, the validation module 120 may receive from the generation module 118 a new pattern piece 130, the measurement file 198, and a pre-defined validation ‘test case’ 3D patterns 220. The new pattern piece 130 may be generated in 3D file 152 format from the structured parametric CAD file 208. Multiple validation ‘test case’ 3D patterns 220 may be made from the parametric formula 206 and from pre-defined ‘test case’ measurements 216 from the storage database 128. The validation module 120 may also receive multiple ‘test case’ 3D avatars 218, as shown in FIGS. 8B and 10D, from the storage database 128. The validation module 120 may then convert the ‘test case’ measurements 216 and parametric formulas 206 to ‘test case’ 3D patterns 220 and digitally sew the ‘test case’ 3D patterns 220 around the multiple ‘test case’ 3D avatars 218, and mathematically check for fit. The validation module 120 may recursively cycle through updating and fine-tuning the parametric formula 206 until the validation module 120 achieves the desired fit on all of the ‘test case’ 3D avatars 218. If the fit results are outside of a defined margin of error, the validation module 120 may adjust the parametric formula 206 and repeat the validation process as needed. For example, new pattern pieces 130 may be exported to a 3D mesh format 222, where the validation module 120 virtually sews the new pattern pieces 130 in 3D mesh format 222 (e.g. ‘test case’ 3D patterns 220) around the ‘test case’ 3D avatars 218 and perform multiple cycles of adjustments to the parametric formula 206 as needed to achieve results within a margin of error. It should be appreciated that the ‘test case’ 3D patterns 220 and the ‘test case’ 3D avatars 218 allow the validation module 120 to check for fit on a wide range of body types to militate against ‘one-size-fits-all’ μl-fitting apparel 236. For example, test case’ 3D avatars 218 may include a 3D mesh format 222 for an ectomorph body type 219, an endomorph body type 221, or a mesomorph body type 223. The 3D avatars 169 utilized by the system, including ‘test case’ 3D avatars 218, may not only expand the sizing customization, but also enhance the efficiency of the validation module 120 by reducing the number of iterations needed to adjust the parametric formula 206.

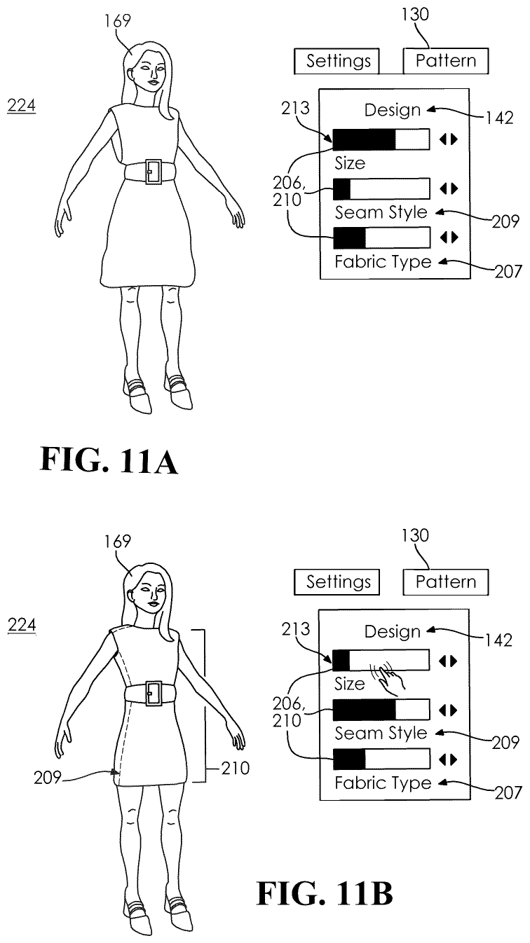

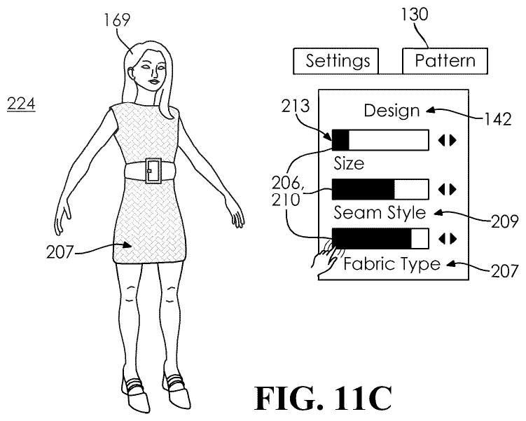

The validation module 120, after validating the parametric formula 206 for precision, may allow the user to visually sew the validated new pattern piece 130 on a 3D avatar 169 using a 3D design environment 224, e.g. a full physics engine, and enable the user to analyze the fit, esthetics, and performance of the new pattern piece 130 in real-time. The design of the new pattern piece 130, including the fit, seam lengths, collar shape, etc. may be adjusted manually through the interface of the 3D design environment 224. The validation module 120 may store any updates to the measurement 148, measurement file 198, parametric formula 206, or structured parametric CAD file 208 as needed. It should be appreciated that the validation module 120 may have the capability to produce a structured parametric CAD file 208 that may be accurately and precisely adjusted in a 3D design environment 224 in real-time without introducing error. Advantageously, the validation module 120 may provide verified and validated a 2D file 150 format or 3D file 152 format (e.g. 3D prototyping assets) and a 2D pattern image 146 that are ready for manufacturing use or further processing in another software tool 238 and systems, and ensures that the user, whether a brand or consumer, is satisfied that the manufactured design option 142 will incorporate the requested style preferences while accurately providing brand sizing or individual fit. As illustrated in FIGS. 11A-11C, the user may select a pre-defined design option 142 in the 3D design environment 224, add or subtract a parametric input 213 including a coefficient 210 of the parametric formula 206 to alter the new pattern piece 130, and update the measurement file 198, parametric formula 206, and the manufacturing instruction 202 in real time. It should be appreciated that the 3D design environment 224 may provide the user with a realistic experience in viewing the new pattern piece 130 on the 3D avatar 169, for example, utilizing a haptic sensor or feedback device corresponding to the fabric type 207, motion detection to allow the user manipulate the 3D avatar 169 with hand gestures, incorporating a physics engine to allow the user to analyze apparel performance by adjusting lighting, wind, humidity, and other physical environment variables, or implementing the 3D avatar 169 and new pattern piece 130 in social media applications.

Referring now to FIGS. 1-2B, and 10A-10D, the application interface module 122 may serve as an interface for the system 100. The application interface module 122 may serve as the point of interaction between a user and the system 100 and interact with hardware 226 including various output devices 228 that may display a representation of the application interface module 122 for observation by the user, where such an output device 228 may include, for example, one or more computer screen, speaker, tablet screen, or other view/audio port, an input device such as a keyboard, microphone, and the like. The application interface module 122 may be accessible via a desktop application 134, smartphone application 135, website 132, 3D design engine 138, or an API 140. The application interface module 122 may be designed to be intuitive and user-friendly, allowing the user to easily interact with the system 100 and visualize changes to the user's apparel 236 design. For example, the application interface module 122 may present and manage the textual and graphical display of the results from the generation module 118 to user via a 3D design engine 138, such as style, fit, sizing, costs, and other user-related data including manufacturing information 230, which may include a list of devices required for fabrication such as sewing machines, fabric cutters, or knitting machines, and to administrators as account data, order history, system 100 status, and other information with features to deploy, query, update, and maintain the system 100.

The application interface module 122 may also allow for a user or manufacturer to view the parametric formula 206 in a user-friendly 3D design environment 224, transfer the parametric formula 206 or structure parametric CAD file to a design manufacturer, or directly transfer the structured parametric CAD file 208 to a manufacturing device 232. For example, the application interface module 122 may utilize the 3D design environment 224 to test and adjust new pattern piece 130 for fit for special events or specific environments, such as testing materials for fireproofing, weather conditions, waterproofing, UV exposure, or aesthetic flow for cinematic production. Upon successful validation of the parametric formula 206 via the validation module 120, the user is notified via the application interface module 122 that the measurement file 198 and structured parametric CAD file 208 are available for download.

The memory 104 may also include a manufacturing module 234 to export the parametric formula 206 to a manufacturing instruction 202. The manufacturing instruction 202 may instruct a manufacturing device 232 in creating an apparel 236. Additionally, the manufacturing module 234 may further refine the manufacturing information 230, including the manufacturing instructions 202. The system 100 may include a manufacturing device 232 to receive the manufacturing instruction 202 from the manufacturing module 234 and manufacture apparel 236 according to the manufacturing instruction 202. For example, the user may provide the manufacturing instruction 202 to the manufacturing device 232 from the manufacturing module 234 via the application interface module 122. The manufacturing device 232 may be utilized by a wide variety of manufacturing and retail users, such as boutique retailers and tailors, small apparel businesses, and custom-order shops. The system 100 may include, or be in communication with, a wide variety of manufacturing devices 232, for example, a commercial manufacturing device 232 or a manufacturing system. For example, the system 100 may provide the parametric formula 206, the structured parametric CAD file 208, the measurement file 198, or a new pattern piece 130 to a commercial manufacturing device 232 (e.g. garment production equipment) for automatic production. It should be appreciated that the system 100 may include the capability to produce a structured parametric CAD file 208 that may communicate comprehensive manufacturing information 230 to a standard commercial manufacturing device 232 (e.g. a manufacturing device 232 that includes a digital interface). The manufacturing module 234 may export a structured parametric CAD file 208 to a variety of interoperable file formats including 2D file 150 formats and 3D file 152 formats, allowing the apparel 236 designs to be used in another software tool 238, such as web catalogs, print, games, phone apps, animation, and film, without the need for company employees to learn additional skillsets. It should also be appreciated that the system 100 may produce a supply of structured parametric CAD files 208 that may reproduce an entire library of apparel 236 designs ‘overnight’ for a company or a brand, without additional training of company employees or hiring hard-to-find master patternmakers.

As shown in FIGS. 12A and 12B, a method 300 is provided for generating a parametric formula 206 for a user from an image 146 and measurement 148 is provided. The method 300 may include a step 302 of providing a processor 102, a memory 104 in communication with the processor 102. The memory 104 may include a receiving module 108, an AI module, a conversion module 116, a validation module 120, a generation module 118, and an application interface module 122. The memory 104 may also include an analysis module 124 and a storage database 128. The receiving module 108 may receive the image 146 and the measurement 148 corresponding to the image 146. The AI module 112 may identify a pattern feature 114 such as a pattern landmark 176, a scam 178, a notch 180, a dart, or another symbol or object 182. The conversion module 116 may convert the image 146 and the measurement 148, to a measurement file 198 and a 3D avatar 169 and the pattern feature 114. The generation module 118 may receive the measurement file 198, the 3D avatar 169, and the pattern feature 114 and generate the parametric formula 206 that receives a parametric input 213, and a structured parametric CAD file 208 including measurement 148 corresponding with the parametric formula 206. The validation module 120 may validate the measurement file 198, the parametric formula 206, the structured parametric CAD file 208, and the 3D avatar 169. The application interface module 122 may display the image 146, the measurement 148, the measurement file 198, structured parametric CAD file 208, the 3D avatar 169, and the parametric formula 206.

The method 300 may include a step 304 of receiving the image 146 and the measurement 148 corresponding to the image 146 via the receiving module 108. The method 300 may include a step 306 of converting the image 146, the measurement 148 to the measurement file 198 and a 3D avatar 169 via the conversion module 116. The method 300 may include a step 308 of converting the image to a pattern feature 114 via the conversion module and the AI module 112. The method 300 may include a step 310 of generating the parametric formula 206 that receives a parametric input 213 from the pattern feature 114 via the generation module 118 and the analysis module 124. The method 300 may include a step 312 of validating the measurement file 198 and 3D avatar 169 for accuracy via the validation module 120. The method 300 may include a step 314 of validating the parametric formula 206 for accuracy via the validation module 120. The method 300 may include a step 316 of validating the parametric formula 206 for precision via the validation module 120. The method 300 may include a step 318 of generating a structured parametric CAD file 208 including a measurement 148 corresponding with the parametric formula 206 using the application interface module 122. The method 300 may include a step 320 of preparing the parametric CAD file 208 and measurement file 198 and notifying the user via the application interface module 122. The parametric CAD file 208 and measurement file 198 may be prepared to be downloaded by the user. The parametric CAD file 208 and measurement file 198 may also be delivered to the user.

As shown in FIG. 13, a method 400 is provided for generating a parametric formula 206 for a user from an image 146 and measurement 148 is provided. The method 400 may include steps 302-304 of method 300 (as steps 402-404 respectively), as shown in FIG. 12A. The method 400 may include a step 406 of may include a step of receiving the image 146 in a JPG 153, PNG 155, PDF 157, DXF 159, OBJ 161, or glTF 163 format. The method 400 may include a step 408 of receiving the measurement 148 in a text file 149 format associated with the image 146. The method 400 may include a step 410 of receiving a tech pack 144 document in combined text and graphics format associated with the image 146. The method 400 may include a step 412 of converting the tech pack 144 to a pattern features 114 via the conversion module 116 and the AI module 112. The method 400 may include steps 306-320 of method 300 (as steps 414-428 respectively), as shown in FIGS. 12A and 12B.

As shown in FIG. 14, a method 500 is provided for generating a parametric formula 206 for a user from an image 146 and measurement 148 is provided. The method 500 may include steps 302-310 of method 300 (as steps 502-510 respectively), as shown in FIGS. 12A and 12B. The method 500 may include a step 512 of generating the parametric formula 206 to include a fabric type 207, a seam style 209, or a rate of fabric shrinkage 211. The method 500 may include a step 514 of structuring the parametric formula 206 with a parametric input 213 via object orientation 215 in a hierarchical data structure 172. The method 500 may include a step 516 of providing a storage database 128 to store the image 146 and the measurement 148 and parametric formula 206 for use in another parametric formula 206, for example future parametric formulas 206. The method 500 may include steps 312-320 of method 300 (as steps 518-526 respectively), as shown in FIG. 12B.

As shown in FIG. 15, a method 600 is provided for generating a parametric formula 206 for a user from an image 146 and measurement 148. The method 600 may include the steps of method 300 (as steps 602-618 respectively), as shown in FIGS. 12A and 12B. The method 600 may include a step 620 of generating a 3D mesh format 222 pattern from the parametric CAD file 208 and the measurement file 198. The method 600 may include a step 622 displaying the 3D mesh format 222 on the 3D avatar 169 via the application interface module 122. The method 600 may include a step 624 of updating the 3D mesh format 222 on the 3D avatar 169 via user input using the application interface module 122. The method 600 may include a step 626 of updating the parametric CAD file 208 to match updates to the 3D mesh format 222 via the application interface module 122. The system 100 may also update the storage database 128. The method 600 may include step 320 of method 300 (as step 628 respectively), as shown in FIG. 12B.

As shown in FIG. 16, a method 700 is provided for generating a parametric formula 206 for a user from an image 146 and measurement 148. The method 700 may include the steps of method 300 (as steps 702-720 respectively), as shown in FIGS. 12A and 12B. The method 700 may include a step 722 of providing in the memory 104 a manufacturing module 234 to export the parametric formula 206 to a manufacturing instruction 202. The method 700 may include a step 724 of providing a manufacturing device 232 to receive the manufacturing instruction 202 from the manufacturing module 234 and manufacture the apparel 236 according to the manufacturing instruction 202. The method 700 may include a step 726 of exporting the parametric formula 206 to the manufacturing instruction 202 to instruct a manufacturing device 232 in creating an apparel 236. The method 700 may include a step 728 of receiving the manufacturing instruction 202 via the manufacturing device 232 from the manufacturing module 234. The method 700 may include a step 730 of operating the manufacturing device 232 to create the apparel 236 according to the manufacturing instruction 202.

Advantageously, the system 100 for generating a parametric formula 206 may provide a comprehensive solution to the inefficiencies and limitations identified in the other apparel 236 design workflows. By utilizing the AI module 112, the system 100 may transform other apparel 236 pattern outlines into scalable and interoperable parametric designs, thereby addressing the challenges of manual pattern generation and the subsequent need for digitization. This approach may significantly enhance design efficiency by eliminating manual steps, enabling agile workflows that reduce time-to-market. The parametric nature of the generated pattern formulas may allow for re-editable and reusable designs, with embedded constraints that militate against errors during modifications. Moreover, the interoperability of these digital patterns may allow for seamless integration across diverse apparel 236 design and manufacturing platforms, facilitating collaboration and reducing bottlenecks associated with non-standardized file formats. Consequently, the present technology may address the unmet need for scalable, efficient, and adaptable patternmaking processes that promote sustainability by reducing fabric waste with precise sizing outcomes, extending size and fit consistency beyond the limitations of linear scaling.

### EXAMPLES

Example embodiments of the present technology are provided with reference to the FIGS. 1-13 enclosed herewith.

### Example: Application of SeamlyConvert™ for Apparel Pattern Conversion

In this example, the system 100 is identified as the SeamlyConvert™ application. The SeamlyConvert™ application is utilized to address a significant challenge in the apparel industry: the high rates of unsold and returned goods due to ill-fitting clothing. This application allows for the replication of any apparel 236 pattern across a variety of sizes and specific measurement 148 in order to reduce unsold inventory and returns due to poor fit, thus reducing waste and inefficiency. Moreover, the application ensures interoperability with any other industry software tool 238 or manufacturing systems by enabling the export of the resulting pattern in any industry format.

The user accesses the application interface module 122 through a web browser. The user uploads a pattern image 146 in JPG 153, PNG 155, PDF 157, DXF 159, OBJ 161, or glTF 163 format, along with its base size measurement 148 either as a text file 149 or by entering the measurement 148 directly into fields provided on the application interface module 122 via the website 132. Once the pattern image 146 has been converted, the user receives an email containing a web link to download the user's Seamly ‘.sm2d’ structured parametric CAD file 208 along with the user's original measurement 148 saved as a Seamly ‘.smis’ measurement file 198. For a user that needs to convert multiple patterns in bulk, a separate website 132 is available where the user can select a folder containing multiple pattern images 146 and a single measurement 148, receiving an email or a set of emails with links to the user's.sm2d files and .smis file. The user may also utilize the application interface module 122 to upload multiple pairs of pattern image 146 with measurement 148, receiving an email or set of emails with links to the user's.sm2d files and .smis files. The user may also utilize the application interface module 122 to upload patterns and enter standard industry base sizes and automatically receive the resulting files.

The application workflow is detailed and robust, involving several steps to ensure accuracy and usability of the converted patterns. Initially, the user may upload an industry standard pattern image 146 in raster file format and measurement 148 in text file format, which are then stored in the storage database 128 for processing. The system 100 preprocesses these files for standardization and ease of processing then locates the closest measurement file 198 match and 3D avatar 169 from an anthropometric database 192 or alternatively generates a 3D avatar 169 from the measurement 148. Additional measurement 148 are generated from the 3D avatar 169, and a SeamlyConvert™ Measurement file 198 (SMIS format) is created. The pattern image 146 is processed with the AI module 112 to identify and pattern piece 130 labels, identify a pattern landmark 176, seam 178, notch 180, or other symbol, as well as identify a dart or another object 182 as pattern features 114. A structured parametric CAD file 208 (SM2D format) is generated with parametric formula 206 selected from the storage database 128 that is customized in response to the output of the AI module 112. Templates of parametric formula 206 are selected based on the new pattern piece 130 labels, and the parametric formula 206 are updated to match the landmark 176, seam 178, notch 180, or object 182 in pattern features 114. A structured parametric CAD file 208 (SM2D format) is generated and validated for accuracy and precision via the validation module 120. The measurement 148 is used as an input to the structured parametric CAD file 208 to generate a new 2D pattern image 146. The new 2D pattern image 146 is compared to the input pattern image 146 to determine the accuracy of the formulas in the structured parametric CAD file 208, and formulas are adjusted as needed. Multiple ‘test case’ 3D patterns 220 are generated from the structured parametric CAD file 208 and a set of validation ‘test case’ measurement 216 that contain body measurement 148 for a variety of sizes. The ‘test case’ 3D patterns 220 are ‘sewn’ around ‘test case’ 3D avatars 218, as shown in FIG. 10D. The system 100 checks if the ‘test case’ 3D patterns 220 fit the ‘test case’ 3D avatars 218 and adjusts formulas as needed to achieve precision in fitting multiple sizes. Finally, the user is notified by email that the user's structured SeamlyConvert™ Design parametric CAD file 208 and SeamlyConvert™ Measurement file 198 are available for download, including a link to access these files. This comprehensive process ensures that the patterns are not only accurate in reproducing the base size or size of the user but are also precision tailored to meet efficient diverse sizing needs.

### Example 2: Custom Apparel Design for Individual Customers

In this example, the application interface module 122 is utilized to create a custom-fitted dress for an individual customer. The customer visits a retail outlet equipped with the system 100 that includes a 3D design environment 224, as illustrated in FIGS. 10A-10D. The customer selects a dress style from a digital catalog and customizes various aspects such as sleeve length, scam style 209, fabric type 207, color, and additional design elements like lace or embroidery, and undergoes a body scan with a 3D body scanner 136. This scan captures detailed body measurement 148, which are then processed with the selected design image 146 and user preferences by the AI module 112 to generate a personalized garment pattern. As shown in FIG. 11A, the customer may view the dress on the 3D avatar 169 to fine-tune the fitting. The customer may change the parametric input 213 including the coefficient 210 of the parametric formula 206 in order to mathematically alter the fitting and size of the dress and alter the seam style 209, as shown FIG. 11B. The customer may also change the fabric type 207, where the system 100 may automatically change the coefficient 210 to meet the requirements of the fabric type 207, as shown in FIG. 11C.

The system 100 adjusts the design pattern of the selected dress according to the specific measurement 148 and preferences of the customer, ensuring a perfect fit. As shown in FIG. 10B, this adjusted pattern is then converted into a manufacturing instruction 202, which is automatically sent to the in-store garment manufacturing device 232. The manufacturing device 232 includes a fabric cutter and a sewing machine, and may be automated or human-assisted, which processes the fabric as per the instruction and assembles the dress within a few hours.

Upon completion, the customer is invited to try on the finished dress. Any minor adjustments needed are quickly made in-store, ensuring customer satisfaction. This example demonstrates the capability of the system 100 to provide tailor-made apparel 236 efficiently, reducing the need for multiple fittings and minimizing fabric waste, thereby enhancing customer experience and operational efficiency.

### Example 3: Immersive Testing in 3D Design Engine 138

In a further example, the system 100 may utilize a 3D design engine 138 to test and adjust apparel 236 for special events or specific environments. A manufacturing company may upload a measurement files 198, or an image 146 of the designs from the catalogue of the manufacturing in order to create a 3D avatar 169 and parametric formula 206. The manufacturing company may create multiple ‘test case’ 3D patterns 220 and ‘test case’ 3D avatars 218 to see how different materials and different fits work in real-world environments.

First, the manufacturing company tests the ‘test case’ 3D patterns 220 on the ‘test case’ 3D avatars 218 with fireproofing, where the 3D design engine 138 allows the manufacturing company to ‘try on’ several materials and test the apparel 236 for combustion levels depending on the material and fit. Next, the manufacturing company tests several ‘test case’ 3D patterns 220 for weather conditions, adjusting apparel 236 for fit, seam styles, sizes, and material to study how the apparel 236 can achieve maximum body-heat retention. Next, the manufacturing company tests several ‘test case’ 3D patterns 220 for military grade protection, testing the patterns on several ‘test case’ 3D avatars 218 of different sizes and proportions, as illustrated in FIG. 10D, in order to account for a wide range of body shapes with various materials, layers, and stitching to compare impacts from simulated projectiles. Finally, the manufacturing company tests several ‘test case’ 3D patterns 220 to compare how a costume for a leading actress in a high-budget film will flow and drape, the manufacturing company altering the costume in real-time to change the performance of fabric, checking for how the fabric type 207 will look in various lighting and with the required movement during action scenes. The various design results, including cost estimates and bill of materials, may be compared and presented to remote team members and management for input, edits, and approvals through a collaborative web-based interface. Alternatively, the immersive testing 3D designs may be leveraged by apparel brands and independent designers for immediate marketing through social media to determine customer ‘favorites’ and collect pre-orders.

### Example 4: Adaptive Clothing Design for Accessibility

In a further example, the system 100 is adapted to design and manufacture clothing for individuals with special needs, focusing on accessibility. The system 100 is used in a medical rehabilitation center where patients with varying physical disabilities can have custom-made clothing to accommodate a patient's specific requirements. For instance, a patient with limited arm mobility may need shirts with magnetic closures instead of traditional buttons.

The rehabilitation center uses the system 100 to scan patients and gather a detailed body measurement 148, considering any unique body shapes or postures due to physical conditions. Patients, along with occupational therapists, select designs from a specialized catalog that features adaptive clothing. They customize features such as a closure, seam 178, or a material to ensure comfort and ease of use.

The customized patterns are processed by the system 100, which adjusts standard designs to meet the specific needs of each patient. The manufacturing instruction 202 is sent to a manufacturing device 232 that specifically handles adaptive clothing designs, ensuring that all garments are functional and fashionable. These custom features not only enhance the quality of life for individuals with disabilities by providing them with better-fitting and functional clothing but also streamlines the production process to make adaptive clothing more widely available and affordable.

### Example 5: Mass Customization for Online Retail

In another example, an online retail store offers mass customization options for a line of formal shirts for men. Customers visiting the online store can input personal measurement 148, which they can obtain from a local tailor or via a guided self-measurement process provided on the website 132. Alternatively, customers can opt for a virtual fitting session using a webcam and augmented reality technology integrated into the website 132.

Once measurement 148 are provided, customers select a preferred shirt style, fabric, and custom options such as cuff type, collar design, and button material. The system 100 receives the measurement 148 and the image 146 in the form of a design illustration and uses these inputs to generate a custom shirt pattern and validates the measurement 148 to ensure that all design elements are proportionally adjusted to fit the body measurement 148 of the customer. The pattern is then processed into an instruction for automated cutting and sewing machines located in regional microfactories.

The shirts are manufactured on-demand and shipped directly to customers, significantly reducing inventory overheads and waste associated with unsold goods. This approach not only offers customers a personalized shopping experience but also aligns with sustainable manufacturing practices by producing garments only when they are ordered.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A system for generating a parametric formula for a user from an image and a measurement, the system comprising:
a processor; and
a memory in communication with the processor, the memory including a receiving module, an artificial intelligence (AI) module, a conversion module, a validation module, a generation module, and an application interface module;
wherein:
the receiving module is configured to receive the image and the measurement corresponding to the image;
the AI module is configured to identify a pattern feature in the image;
the conversion module is configured to convert the image, the measurement, and the pattern feature to a measurement file and a 3D avatar;
the generation module is configured to receive the measurement file, the 3D avatar, and the pattern feature and generate the parametric formula configured to receive a parametric input, and further configured to generate a structured parametric CAD file including measurement corresponding with the parametric formula;
the validation module is configured to validate the measurement file, the parametric formula, the structured parametric CAD file, and the 3D avatar; and
the application interface module is configured to display the image, the measurement, the measurement file, the structured parametric CAD file, the 3D avatar, and the parametric formula.

2. The system of claim 1, wherein the image is uploaded via the application interface module in a format selected from a group consisting of JPG, PNG, PDF, DXF, OBJ, and glTF.

3. The system of claim 1, wherein the parametric formula includes a member selected from a group consisting of a fabric type, a seam style, a rate of fabric shrinkage, and combinations thereof.

4. The system of claim 1, wherein the parametric formula is further configured to structure a parametric input via object orientation in a hierarchical data structure.

5. The system of claim 1, wherein the measurement is uploaded to the application interface module in a text file format.

6. The system of claim 1, wherein the pattern feature identified by the AI module includes a member selected from a group consisting of a pattern landmark, a seam, a notch, and combinations thereof.

7. The system of claim 1, wherein the memory further includes an analysis module configured to receive and analyze the image and the measurement.

8. The system of claim 1, wherein the memory further comprises a manufacturing module configured to export the parametric formula to a manufacturing instruction, the manufacturing instruction configured to instruct a manufacturing device in creating an apparel.

9. The system of claim 8, further comprising a manufacturing device configured to receive the manufacturing instruction from the manufacturing module and manufacture the apparel according to the manufacturing instruction.

10. The system of claim 1, further comprising a storage database configured to store the image and the measurement for use in generating another parametric formula.

11. A method for generating a parametric formula for a user from an image and measurement, comprising:
providing a processor, a memory in communication with the processor, the memory including a receiving module, an artificial intelligence (AI) module, a conversion module, a validation module, a generation module, and an application interface module,
wherein:
the receiving module is configured to receive the image and the measurement corresponding to the image,
the AI module is configured to identify a pattern feature in the image,
the conversion module is configured to convert the image, the measurement, and the pattern feature to a measurement file and a 3D avatar,
the generation module is configured to receive the measurement file, the 3D avatar, and pattern feature and generate the parametric formula configured to receive a parametric input, and a structured parametric CAD file including measurement corresponding with the parametric formula,
the validation module is configured to validate the measurement file, the parametric formula, the structured parametric CAD file, and the 3D avatar, and
the application interface module is configured to display the image, the measurement, the measurement file, the structured parametric CAD file, the 3D avatar, and the parametric formula;
receiving the image and the measurement corresponding to the image via the receiving module;
converting the measurement to the measurement file and the 3D avatar via the conversion module;
converting the image to the pattern feature via the conversion module and the AI module;
generating the parametric formula configured to receive a parametric input from the pattern feature via the generation module;
generating a structured parametric CAD file including measurement corresponding with the parametric formula;
validating the measurement file and 3D avatar for accuracy via the validation module;
validating the parametric formula for accuracy via the validation module;
validating the parametric formula for precision via the validation module;
generating a structured parametric CAD file including the measurement corresponding with the parametric formula using the application interface module;
preparing the parametric CAD file and measurement file; and
notifying the user via the application interface module.

12. The method of claim 11, wherein the image is received in a format selected from the group consisting of JPG, PNG, PDF, DXF, OBJ, and glTF.

13. The method of claim 11, wherein the parametric formula includes a member selected from the group consisting of a fabric type, a seam style, a rate of fabric shrinkage, and combinations thereof.

14. The method of claim 11, wherein the pattern feature identified by the AI module includes a member selected from a group consisting of a pattern landmark, a seam, a notch, and combinations thereof.

15. The method of claim 11, wherein the parametric formula is further configured to structure a parametric input via object orientation in a hierarchical data structure.

16. The method of claim 11, wherein the measurement is provided in a text file format associated with the image.

17. The method of claim 11, wherein the memory further includes an analysis module configured to receive and analyze the image and the measurement.

18. The method of claim 11, further comprising a storage database configured to store the image and the measurement for use in generating another parametric formula.

19. The method of claim 11, further comprising:
providing in the memory a manufacturing module configured to export the parametric formula to a manufacturing instruction; and
exporting the parametric formula to the manufacturing instruction configured to instruct a manufacturing device in creating an apparel.

20. The method of claim 19, further comprising:
providing a manufacturing device configured to receive the manufacturing instruction from the manufacturing module and manufacture the apparel according to the manufacturing instruction;
receiving the manufacturing instruction via the manufacturing device from the manufacturing module; and
operating the manufacturing device to create the apparel according to the manufacturing instruction.
